(19) United States
(12) Patent Application Publication
(10) Pub. No.: US 2026/0347654 A1
(43) Pub. Date: Nov. 5, 2026

(54) THREE-DIMENSIONAL PRINTING

(71) Applicant: PERIDOT PRINT LLC, Palo Alto, CA (US)

(72) Inventors: Jake H. Thomas, San Diego, CA (US); Emre Hiro Discekici, San Diego, CA (US); Emily Levin, San Diego, CA (US); Shannon Reuben Woodruff, San Diego, CA (US)

(21) Appl. No.: 19/123,317

(22) PCT Filed: Oct. 28, 2022
(86) PCT No.: PCT/US2022/048216

§ 371 Date: Apr. 22, 2025

(51) Int. Cl. C09D 191/06; B29C 64/165; B29K 27/12; B29K 77/00; B29K 105/00; B33Y 10/00; B33Y 40/00; B33Y 70/10; C09D 127/18; C09D 129/10

(52) U.S. Cl. CPC C09D 191/06; B29C 64/165; B33Y 10/00; B33Y 40/00; B33Y 70/10; C09D 127/18; C09D 129/10; B29K 2027/12; B29K 2077/00; B29K 2105/0005

(57) ABSTRACT

A multi-functional agent for three-dimensional printing includes: an aqueous vehicle; a hydrophobic component dispersed in the aqueous vehicle, the hydrophobic component being selected from the group consisting of a perfluorinated polymer and a paraffin wax; and an energy absorber dispersed in the aqueous vehicle. The multi-functional agent may be used to print a three-dimensional object having a hydrophobic region.

### BACKGROUND

Three-dimensional (3D) printing may be an additive printing process used to make three-dimensional solid parts from a digital model. 3D printing is often used in rapid product prototyping, mold generation, mold master generation, and short run manufacturing. Some 3D printing techniques are considered additive processes because they involve the application of successive layers of material (which, in some examples, may include build material, binder and/or other printing liquid(s), or combinations thereof). This is unlike traditional machining processes, which often rely upon the removal of material to create the final part. Some 3D printing methods use chemical binders or adhesives to bind build materials together. Other 3D printing methods involve at least partial curing, thermal merging/fusing, melting, sintering, etc. of the build material, and the mechanism for material coalescence may depend upon the type of build material used. For some materials, at least partial melting may be accomplished using heat-assisted extrusion, and for some other materials (e.g., polymerizable materials), curing or fusing may be accomplished using, for example, ultra-violet light or infrared light.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a schematic diagram illustrating an example of a 3D printing technique utilizing a multi-functional agent described herein;

FIG. 2 schematically illustrates an example of a fluid set including an example of a hydrophobic agent and an example of a fusing agent;

FIG. 3 is a schematic diagram illustrating an example of a 3D printing technique utilizing an example of a hydrophobic agent and an example of a fusing agent described herein; and

FIG. 4 is a photograph, reproduced in black and white, of a 3D object formed with an example of a multi-functional agent described herein and a comparative 3D object, each object having a drop of water applied thereto.

### DETAILED DESCRIPTION

Some three-dimensional (3D) printing methods utilize an energy absorbing substance (e.g., an energy absorber) to pattern a build material composition. In these methods, an entire layer of the build material composition (comprised of build material particles) is exposed to radiation, but the patterned region of the build material composition is coalesced/fused and becomes a layer of a 3D printed object. In the patterned region, the energy absorbing substance is capable of at least partially penetrating into voids between the particles of the build material composition, and is also capable of spreading onto an exterior surface of build material particles. The energy absorbing substance is also capable of converting absorbed radiation energy into thermal energy, which coalesces/fuses build material particles that have been patterned with the energy absorbing substance. Fusing/coalescing causes the build material particles to join/blend to form a single entity (i.e., the layer of the 3D printed object). Fusing/coalescing may involve at least partial thermal merging, melting, binding, and/or some other mechanism that causes the build material composition to form the layer of the 3D object.

The surface properties of 3D printed objects generated with these methods are generally dictated by the properties of a bulk build material that is used to form the object. For example, 3D printed objects generated with polyamide-6,6 tend to be more hydrophilic than 3D printed objects generated with, e.g., polypropylene or polyamide-12. However, manufacturing processes can lead to physical characteristics (e.g., porosity) which allow for surface wetting and water permeation, even in 3D printed objects formed from relatively hydrophobic bulk build materials.

In the examples disclosed herein, a multi-functional agent, or a fluid set including a hydrophobic agent and a fusing agent, may be used to generate 3D printed parts with tailored surface hydrophobicity. The tailored surface hydrophobicity may be vastly different from the intrinsic property of the bulk build material that is used to form the parts. This is due to the fact that the multi-functional agent or the hydrophobic agent is selectively jetted onto a portion of the build material composition during the printing process. The ability to jet (i) the multi-functional agent or (ii) the hydrophobic agent (and the fusing agent) via any suitable inkjet printing technique enables controlled (and potentially varying) hydrophobicity to be spatially incorporated into 3D printed objects at the voxel level.

Still further, the multi-functional agent and the hydrophobic agent disclosed herein alter the water repellency property of the bulk build material without significant chemical modification to the bulk build material.

The introduction of surface hydrophobicity to 3D printed objects can help to maintain surfaces that are clean and/or dry. In some applications, clean and/or dry surfaces can also help to prevent ice formation, reduce rust formation, and increase protection of electrical systems.

The multi-functional agent disclosed herein is a single agent that includes both an energy absorber and a hydrophobic component, and therefore acts as an energy absorbing substance in addition to imparting hydrophobicity to build material particles (hence the agent is “multi-functional”). When this single agent is printed from a single ink slot or nozzle of a dual slotted inkjet pen, the other slot of this type of inkjet pen may be used to dispense another agent, such as a detailing agent. The availability of the other slot for dispensing another agent facilitates versatility in the printing process.

Throughout this disclosure, a weight percentage that is referred to as “wt % active” refers to the loading of an active component of a stock formulation that is present, e.g., in the multi-functional agent, etc. For example, an energy absorber, such as carbon black, may be present in a water-based formulation (e.g., a stock solution or dispersion) before being incorporated into the multi-functional agent and/or the fusing agent. In this example, the wt % active of the carbon black accounts for the loading (as a weight percent) of the carbon black solids that are present in the multi-functional agent or the fusing agent, and does not account for the weight of the other components (e.g., water, etc.) that are present in the stock solution or dispersion with the carbon black. The term “wt %,” without the term actives, refers to the loading (e.g., in the multi-functional agent) of a 100% active component that does not include other non-active components therein.

Printing with a Multi-Functional Agent

### Multi-Functional Agent

Described herein are examples of a multi-functional agent for three-dimensional printing, comprising: an aqueous vehicle; a hydrophobic component dispersed in the aqueous vehicle, the hydrophobic component being selected from the group consisting of a perfluorinated polymer and a paraffin wax; and an energy absorber dispersed in the aqueous vehicle. As explained, the multi-functional agent is capable of imparting hydrophobicity to a corresponding portion of a 3D object formed from build material particles that have been patterned with the agent and can also act as an energy absorbing substance.

In any example of the multi-functional agent, the aqueous vehicle is selected from the group consisting of water, a water-soluble or water-miscible organic co-solvent, and combinations thereof.

Suitable water-soluble or water-miscible organic co-solvents include aliphatic alcohols, aromatic alcohols, diols, glycol ethers, polyglycol ethers, lactams, formamides (substituted and unsubstituted), acetamides (substituted and unsubstituted), glycols, and long chain alcohols. Examples of these co-solvents include primary aliphatic alcohols, secondary aliphatic alcohols, 1,2-alcohols (e.g., 1,2-ethanediol, 1,2-propanediol, etc.), 1,3-alcohols (e.g., 1,3-propanediol), 1,5-alcohols (e.g., 1,5-pentanediol), 1,6-hexanediol or other diols (e.g., 2-methyl-1,3-propanediol, etc.), ethylene glycol alkyl ethers, propylene glycol, propylene glycol alkyl ethers, higher homologs (C₆-C₁₂) of polyethylene glycol alkyl ethers, diethylene glycol, triethylene glycol, tripropylene glycol methyl ether, tetraethylene glycol, glycerol, N-alkyl caprolactams, unsubstituted caprolactams, 2-pyrrolidone, 1-methyl-2-pyrrolidone, 1-(2-hydroxyethyl)-2-pyrrolidone, and combinations thereof. Other examples of organic co-solvents include dimethyl sulfoxide (DMSO), isopropyl alcohol, ethanol, pentanol, and combinations thereof. It is to be understood that some of the co-solvents, e.g., glycol ether and propylene glycol, may also function as a humectant. In some embodiments, the co-solvent has a boiling point higher than water (e.g., above 100 °C).

The total amount of co-solvent(s) in the multi-functional agent ranges from about 1 wt % active to about 65 wt % active, based on the total weight of the multi-functional agent. In an example, the co-solvent is present in the multi-functional agent in a total amount of about 15.0 wt % active.

When the energy absorber multi-functional agent is the visible radiation absorbing dye, two co-solvents may be selected, one of which is a plasticizer and/or may have plasticizing characteristics when interacting with the build material composition and the other of which is water miscible. As an example, the first of the two co-solvents may be benzyl alcohol or diethylene glycol butyl ether (DEGBE) (present at 10 wt % active to about 40 wt % active) and the second of the two co-solvents may be at least one of diethylene glycol (DEG) butyl ether, 1,2-hexanediol, hydroxyethyl-2-pyrrolidone (HE2P), glycerol, propylene glycol and its oligomers, ethylene glycol and its oligomers, or 1,5-pentanediol (present at 30 wt % active to about 60 wt % active).

In some examples of the multi-functional agent, the hydrophobic component is the perfluorinated polymer. The perfluorinated polymer may be any perfluorinated polymer capable of being 3D printed. When used in the multi-functional agent disclosed herein, it has been found that the perfluorinated polymer can effectively intermingle with build material particles (after being printed thereon) without inhibiting the function of the energy absorber in the multi-functional agent. The perfluorinated polymer, when used in the multi-functional agent, becomes embedded in coalesced build material, which results in a hydrophobic 3D printed layer.

In these examples, the perfluorinated polymer is selected from the group consisting of a perfluoroalkoxy alkane, poly(tetrafluoroethylene), a perfluorinated polyether, fluorinated ethylene propylene, and combinations thereof.

The perfluorinated polymer (when included in the multi-functional agent) has an average particle size ranging from about 50 nm to about 195 nm. The term “average particle size”, as used herein, refers to the diameter of a spherical particle, or the average diameter of a non-spherical particle (i.e., the average of multiple diameters across the particle), or the volume-weighted mean diameter of a particle distribution.

Examples of a perfluoroalkoxy alkane have a chemical structure of:

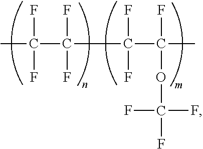

where n is greater than 5 and less than 100,000 and m is greater than 5 and less than 100,000. One suitable example of the perfluoroalkoxy alkane includes DYNEON™ Fluoroplastic Dispersion PFA 6910GZ (available from 3M™). Examples of poly(tetrafluoroethylene) have a chemical structure of:

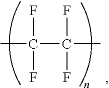

where n is greater than 5 and less than 100,000. An example of poly(tetrafluoroethylene) includes TEFLON® (available from E. I. du Pont de Nemours and Company). Examples of a perfluorinated polyether have a chemical structure of:

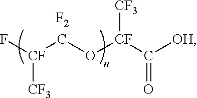

where n is greater than 5 and less than 100,000. In some examples of the perfluorinated polyether, n ranges from 10 to 60. Examples of a perfluorinated polyether include KRYTOX™ lubricants (available from The Chemours Company). Examples of fluorinated ethylene propylene have a chemical structure of:

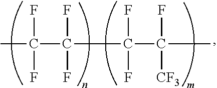

where n is greater than 5 and less than 100,000 and m is greater than 5 and less than 100,000.

The perfluorinated polymer may be incorporated into the aqueous vehicle of the multi-functional agent as a perfluorinated polymer dispersion. The perfluorinated polymer may be dispersed in water alone or in combination with a water-soluble or water-miscible organic co-solvent. The water-soluble or water-miscible organic co-solvents described in reference to the aqueous vehicle of the multi-functional agent are also suitable for use in the perfluorinated polymer dispersion. It is to be understood, however, that in this example, the liquid components of the perfluorinated polymer dispersion become part of the aqueous vehicle of the multi-functional agent.

The amount of the perfluorinated polymer in the dispersion may range from about 20 wt % to about 60 wt %, based on a total weight of the perfluorinated polymer dispersion. The perfluorinated polymer dispersion may then be incorporated into the multi-functional agent vehicle so that the perfluorinated polymer is present in an active amount that is suitable (i) for generating a part with the desired properties and (ii) for the printing architecture that is to be used. In some examples, the perfluorinated polymer is present (in the multi-functional agent) in a total amount ranging from about 5 wt % active to about 20 wt % active, based on a total weight of the multi-functional agent. In other examples, the perfluorinated polymer is present in a total amount ranging from about 7.5 wt % active to about 17.5 wt % active, or from about 7.5 wt % active to about 15 wt % active, or from about 8 wt % active to about 12 wt % active, or from about 9 wt % active to about 11 wt % active, based on the total weight of the multi-functional agent. In one example, the perfluorinated polymer is present in the multi-functional agent in a total amount of about 10.0 wt % active.

The multi-functional agent further includes the energy absorber. In examples where the hydrophobic component is the perfluorinated polymer, the energy absorber is selected from the group consisting of an infrared radiation absorbing non-self-dispersed pigment, an infrared radiation absorbing dye, a visible radiation absorbing pigment, a visible radiation absorbing dye, and an ultraviolet radiation absorber. It is to be understood that the terms “infrared radiation absorbing non-self-dispersed pigment(s)” and/or “infrared radiation absorbing dye(s)” encompass near-infrared absorbing non-self-dispersed pigment(s) and/or dyes. It is to be further understood that some of the energy absorbers are capable of absorbing both visible and infrared radiation or both ultraviolet and visible radiation.

In some examples, the energy absorber may be the infrared radiation absorbing non-self-dispersed pigment or the infrared radiation absorbing dye. Any infrared radiation absorbing non-self-dispersed pigments and infrared radiation absorbing dyes, e.g., those produced by Fabricolor, Eastman Kodak, or BASF, Yamamoto, may be used as the energy absorber. As one example, the energy absorber may be a printing liquid formulation including non-self-dispersed carbon black. Examples of this printing liquid formulation are commercially known as CM997A, 516458, C18928, C93848, C93808, or the like, all of which are available from HP Inc. These examples are also capable of absorbing visible light.

Some examples of the infrared radiation absorbing dye are water-soluble infrared radiation absorbing dyes selected from the group consisting of:

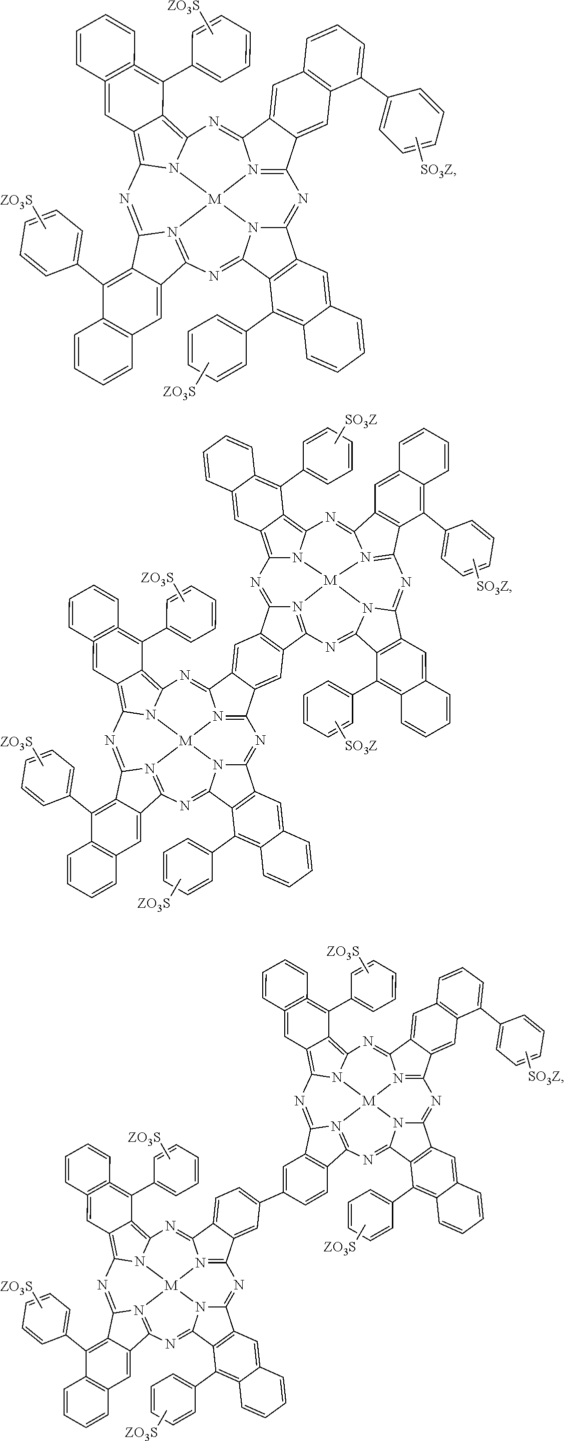

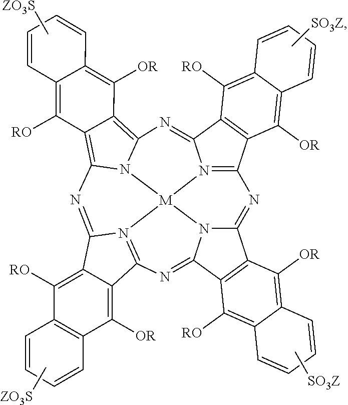

and mixtures thereof. In the above formulations, M can be a divalent metal atom (e.g., copper, etc.) or can have OSO₃Na axial groups filling any unfilled valencies if the metal is more than divalent (e.g., indium, etc.), R can be hydrogen or any C₁-Cₐ alkyl group (including substituted alkyl and unsubstituted alkyl), and Z can be a counterion such that the overall charge of the infrared absorbing dye is neutral. For example, the counterion can be sodium, lithium, potassium, NH₄⁺, etc.

Some other examples of the infrared absorbing dye are hydrophobic near-infrared absorbing dyes selected from the group consisting of:

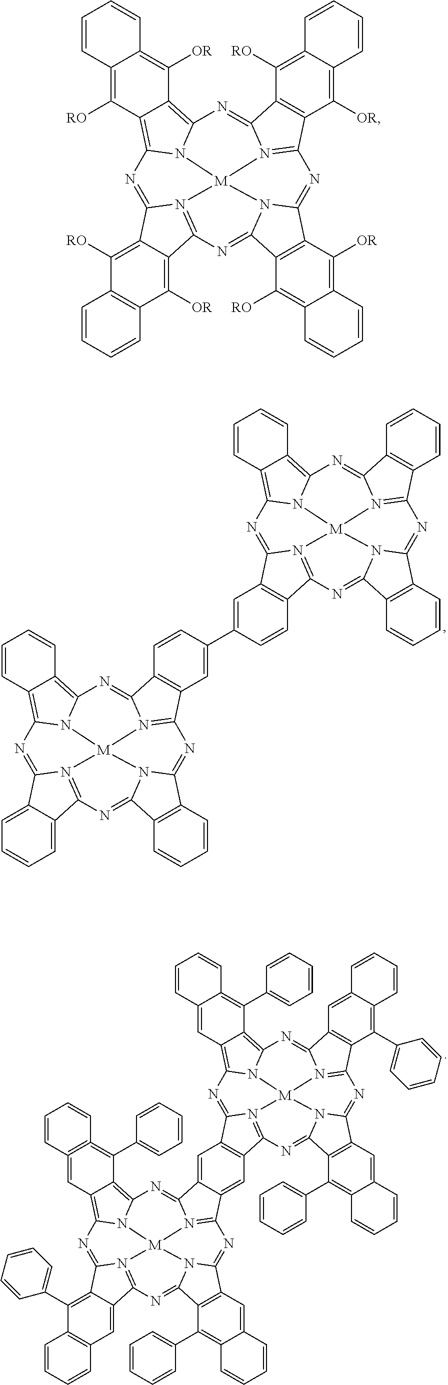

and mixtures thereof. For the hydrophobic near-infrared absorbing dyes, M can be a divalent metal atom (e.g., copper, etc.) or can include a metal that has Cl, Br, or OR′ (R′=H, CH₃, COCH₃, COCH₂COOCH₃, COCH₂COCH₃) axial groups filling any unfilled valencies if the metal is more than divalent, and R can be hydrogen or any C₁-C₈ alkyl group (including substituted alkyl and unsubstituted alkyl).

Other near-infrared absorbing dyes or pigments may be used in the multi-functional agent. Some examples include anthraquinone dyes or pigments, metal dithiolene dyes or pigments, cyanine dyes or pigments, perylenediimide dyes or pigments, croconium dyes or pigments, pyrilium or thiopyrilium dyes or pigments, boron-dipyrromethene dyes or pigments, or aza-boron-dipyrromethene dyes or pigments.

Anthraquinone dyes or pigments and metal (e.g., nickel) dithiolene dyes or pigments may have the following structures, respectively:

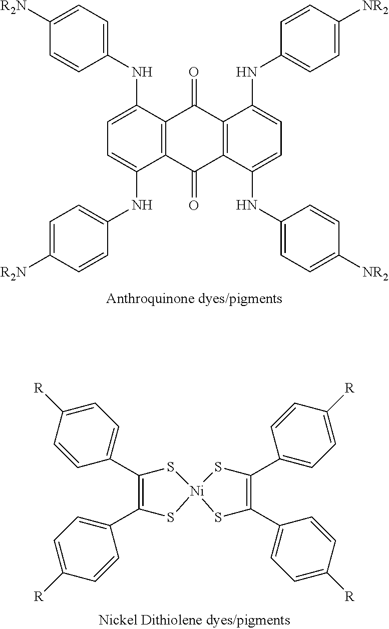

where R in the anthraquinone dyes or pigments can be hydrogen or any C₁-C₈ alkyl group (including substituted alkyl and unsubstituted alkyl), and R in the dithiolene can be hydrogen, COOH, SO₃, NH₂, any C₁-C₈ alkyl group (including substituted alkyl and unsubstituted alkyl), or the like.

Cyanine dyes or pigments and perylenediimide dyes or pigments may have the following structures, respectively:

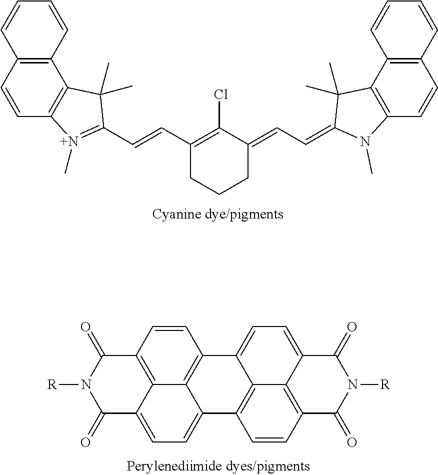

where R in the perylenediimide dyes or pigments can be hydrogen or any C₁-C₈ alkyl group (including substituted alkyl and unsubstituted alkyl).

Croconium dyes or pigments and pyrilium or thiopyrilium dyes or pigments may have the following structures, respectively:

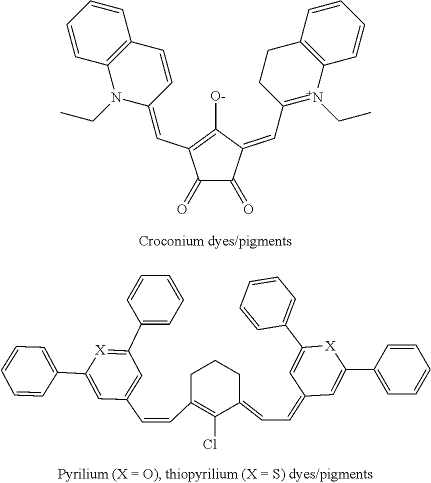

Boron-dipyrromethene dyes or pigments and aza-boron-dipyrromethene dyes or pigments may have the following structures, respectively

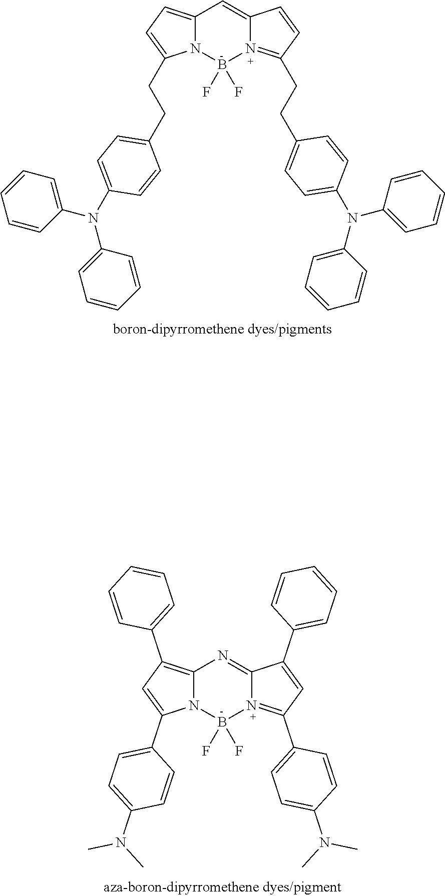

Other suitable near-infrared absorbing dyes may include aminium dyes, tetraaryldiamine dyes, phthalocyanine dyes, and others.

In some examples of the multi-functional agent where the hydrophobic component is the perfluorinated polymer, the energy absorber is the visible radiation absorbing dye. Examples of the visible radiation absorbing dye include acid yellow 23 (AY 23) or AY 1 (or other yellow dyes utilized with a 455 nm fusing lamp), cyan 854 (or other cyan dyes utilized with a 365 nm fusing lamp), pyranine, and direct black 168 (DB-168).

In some examples of the multi-functional agent where the hydrophobic component is the perfluorinated polymer, the energy absorber is the ultraviolet (UV) radiation absorber. In these examples, the UV radiation absorber is a molecule or compound having absorption at wavelengths ranging from 100 nm to 400 nm. The UV radiation absorber efficiently absorbs the UV radiation, converts the absorbed UV radiation to thermal energy, and promotes the transfer of the thermal heat to a build material composition in order to coalesce the build material composition.

The UV radiation absorber can be used with a narrow-band emission source, such as UV light emitting diodes (LEDs). This source reduces the band of photon energies to which the build material that is not patterned with the multi-functional agent is exposed and thus potentially absorbs. This can lead to more accurate object shapes and reduced rough edges. Some UV radiation absorbers are substantially colorless and thus can generate much lighter (e.g., white, off-white, or even translucent) 3D objects than infrared (IR) and/or visible radiation absorbing materials.

Some examples of UV radiation absorbers include a B vitamin and/or a B vitamin derivative. Any B vitamins and/or B vitamin derivatives that are water soluble and that have absorption at wavelengths ranging from about 340 nm to about 415 nm may be used as the UV radiation absorber. As used herein, the phrase “that has absorption at wavelengths ranging from about 340 nm to about 415 nm” means that the B vitamin or B vitamin derivative exhibits maximum absorption at a wavelength within the given range and/or has an absorbance of about 0.1 (about 80% transmittance or less) at one or more wavelengths within the given range. Some of the B vitamins or B vitamin derivatives have lower absorbance. These B vitamins or B vitamin derivatives can still result in suitable coalescence and fusing when they are coupled with a higher intensity and/or a higher dose (where dose=intensity*radiation time).

Examples of suitable B vitamins include riboflavin (vitamin B2), pantothenic acid (vitamin B5), pyridoxine (one form of vitamin B6), pyridoxamine (another form of vitamin B6), biotin (vitamin B7), folic acid (synthetic form of vitamin B9), cyanocobalamin (synthetic form of vitamin B12), and combinations thereof. Examples of suitable B vitamin derivatives include flavin mononucleotide, pyridoxal phosphate hydrate, pyridoxal hydrochloride, pyridoxine hydrochloride, and combinations thereof. Any combination of one or more B vitamins and one or more B vitamin derivatives may also be used. This may be desirable, for example, when one vitamin or vitamin derivative is less absorbing.

Another example of a suitable UV radiation absorber is a functionalized benzophenone. Some of the functionalized benzophenones have absorption at wavelengths ranging from about 340 nm to 405 nm. The phrase “have absorption at wavelengths ranging from about 340 nm to about 405 nm” means that the functionalized benzophenone exhibits maximum absorption at a wavelength within the given range and/or has an absorbance of about 0.1 (about 80% transmittance or less) at one or more wavelengths within the given range.

The functionalized benzophenone is benzophenone substituted with at least one hydrophilic functional group. The functionalization may render the substituted benzophenone more hydrophilic than benzophenone and/or may shift the absorption of the substituted benzophenone to the desired UV range (340 nm to 405 nm). As such, the functionalized benzophenone is a benzophenone derivative including at least one hydrophilic functional group. In some examples, the functionalized benzophenone is benzophenone substituted with one hydrophilic functional group. In other examples, the functionalized benzophenone is benzophenone substituted with two hydrophilic functional groups. In still other examples, the functionalized benzophenone is benzophenone substituted with three hydrophilic functional groups. In the examples where the benzophenone is substituted with multiple functional groups, these groups may be the same or different. Examples of the hydrophilic functional group may be selected from the group consisting of an amine group, a hydroxy group, an alkoxy group, a carboxylic acid group, or a sulfonic acid group.

In examples where the at least one hydrophilic functional group is the amine group, the functionalized benzophenone is selected from the group consisting of 4-aminobenzophenone:

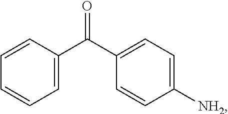 [SMILES: Nc1ccc(C(=O)c2ccccc2)cc1]

4-dimethylaminobenzophenone:

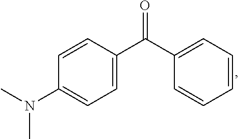 [SMILES: CN(C)c1ccc(C(=O)c2ccccc2)cc1]

and combinations thereof.

In examples where the at least one hydrophilic functional group is the hydroxy group, the functionalized benzophenone is selected from the group consisting are 4-hydroxy-benzophenone:

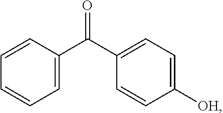 [SMILES: O=C(c1ccccc1)c1ccc(O)cc1]

2,4-dihydroxy-benzophenone:

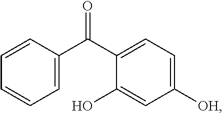 [SMILES: O=C(c1ccccc1)c1ccc(O)cc1O]

4,4-dihydroxy-benzophenone:

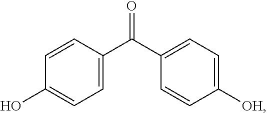 [SMILES: O=C(c1ccc(O)cc1)c1ccc(O)cc1]

2,4,4′-trihydroxy-benzophenone:

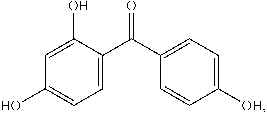 [SMILES: O=C(c1ccc(O)cc1)c1ccc(O)cc1O]

2,4,6-trihydroxy-benzophenone:

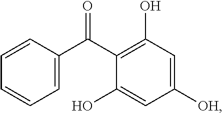 [SMILES: O=C(c1ccccc1)c1c(O)cc(O)cc1O]

2,2′,4,4′-tetrahydroxy-benzophenone:

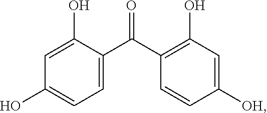 [SMILES: O=C(c1ccc(O)cc1O)c1ccc(O)cc1O]

2,3,4-trihydroxy-benzophenone:

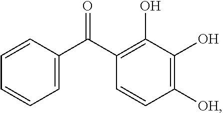 [SMILES: O=C(c1ccccc1)c1ccc(O)c(O)c1O]

2,3,4,4′-tetrahydroxy-benzophenone:

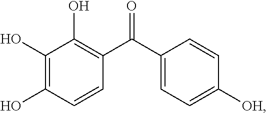 [SMILES: O=C(c1ccc(O)cc1)c1ccc(O)c(O)c1O]

and combinations thereof.

In examples where the at least one hydrophilic functional group is the alkoxy group, the functionalized benzophenone is 4,4′-dimethoxybenophenone:

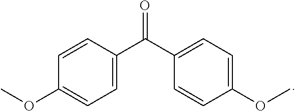

In other examples, the functionalized benzophenone may contain hydrophilic functional groups that are different. In these examples, the functionalized benzophenone is a benzophenone derivative including at least two different hydrophilic functional groups.

In one example, a first hydrophilic functional group of the at least two different hydrophilic functional groups is an alkoxy group, and a second hydrophilic functional group of the at least two different hydrophilic functional groups is a hydroxyl group. Some examples of these functionalized benzophenones include 2-hydroxy-4-dodecyloxy-benzophenone:

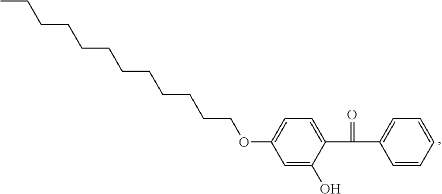 [SMILES: CCCCCCCCCCCCOc1ccc(C(=O)c2ccccc2)c(O)c1]

2-hydroxy-4-methoxy-benzophenone:

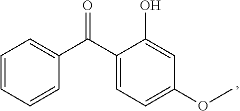 [SMILES: COc1ccc(C(=O)c2ccccc2)c(O)c1]

2,2′-hydroxy-4-methoxy-benzophenone:

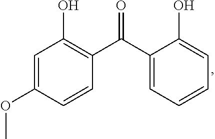 [SMILES: COc1ccc(C(=O)c2ccccc2O)c(O)c1]

and combinations thereof.

In another example, a first hydrophilic functional group of the at least two different hydrophilic functional groups may be selected from the group consisting of a hydroxy group and a carboxylic acid group, and a second hydrophilic functional group of the at least two different hydrophilic functional groups is an alkyl group. Some examples of these functionalized benzophenones include 2-hydroxy-4-methyl-benzophenone:

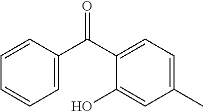 [SMILES: Cc1ccc(C(=O)c2ccccc2)c(O)c1]

and 4′-Methylbenzo-phenone-2-carboxylic acid:

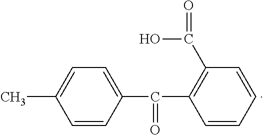 [SMILES: Cc1ccc(C(=O)c2ccccc2C(=O)O)cc1]

In yet another example, a first hydrophilic functional group of the at least two different hydrophilic functional groups is a hydroxy group, a second hydrophilic functional group of the at least two different hydrophilic functional groups is an alkoxy group, and a third hydrophilic functional group of the at least two different hydrophilic functional groups is a sulfonic acid group. An example of this functionalized benzophenone is 2-hydroxy-4-methoxy-benzophenone-5-sulfonic acid.

Examples of the functionalized benzophenones include 4-hydroxy-benzophenone, 2,4-dihydroxy-benzophenone, 4,4 dihydroxy-benzophenone, 2,4,4′-trihydroxy-benzophenone, 2,4,6 trihydroxy-benzophenone, 2,2′,4,4′-tetrahydroxy-benzophenone, 4,4′-dimethoxybenzophenone, 4-aminobenzophenone, 4-dimethylamino-benzophenone, 2-hydroxy-4-methyl-benzophenone, 4′-methylbenzo-phenone-2-carboxylic acid, 2-hydroxy-4-dodecyloxy-benzophenone, 2-hydroxy-4-methoxy-benzophenone, 2-hydroxy-4-methoxy-benzophenone-5-sulfonic acid, 2,3,4-trihydroxy-benzophenone, 2,3,4,4′-tetrahydroxy-benzophenone, 2,2′-hydroxy-4-methoxy-benzophenone, and combinations thereof.

While several examples of functionalized benzophenones have been provided herein, it is to be understood that any benzophenone substituted with at least one hydrophilic functional group may be used as the UV energy absorber. These may be naturally occurring or synthesized. As examples, benzophenone derivatives with at least one poly(ethylene glycol) (PEG) chain or with at least one phosphocholine chain may be synthesized.

The functionalized benzophenone, when used, is at least partially soluble in the aqueous vehicle of the multi-functional agent. The phrase “at least partially soluble” means that at least 0.5 wt % of the functionalized benzophenone is able to dissolve in the aqueous vehicle (of the multi-functional agent).

Still another example of UV radiation absorber is a plasmonic metal nanoparticle that provides absorption enhancement at radiation wavelengths ranging from about 340 nm to about 450 nm.

In an example, the plasmonic metal nanoparticle is selected from the group consisting of silver nanoparticles, gold nanoparticles, copper nanoparticles, aluminum nanoparticles, and combinations thereof. The example plasmonic metal nanoparticles absorb the UV radiation in the selected range, and they also exhibit enhanced absorption caused by localized surface plasmon resonance in the near-UV and the high photon energy end of visible range (e.g., from 340-450 nm). The phrase “absorbs radiation at wavelengths ranging from about 340 nm to about 450 nm” means that the plasmonic metal nanoparticle exhibits maximum absorption at a wavelength within the given range and/or has an absorbance greater than 1 (about 10% transmittance or less) at one or more wavelengths within the given range.

The plasmonic metal nanoparticle may have an average particle size ranging from about 1 nm to about 200 nm. In one example, the plasmonic metal nanoparticle has an average particle size ranging from about 1 nm to about 100 nm. In another example, the plasmonic metal nanoparticle has an average particle size ranging from about 1 nm to about 50 nm. In some examples, the plasmonic metal nanoparticle within a distribution of the particles can have a median diameter (D50) ranging from about 50 nm to about 150 nm. In an example, the median value may be weighted by volume (i.e., volume-weighted mean diameter).

Yet another example of a suitable UV radiation absorber is a fluorescent yellow dye having a targeted wavelength of maximum absorption for a 3D print system including the narrow UV-band emission source.

The fluorescent yellow dye may be pyranine:

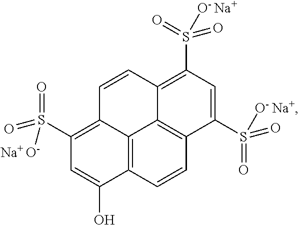

a pyranine derivative, coumarin:

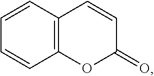 [SMILES: O=c1ccc2ccccc2o1]

a coumarin derivative, a naphthalimide:

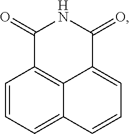 [SMILES: O=C1NC(=O)c2cccc3cccc1c23]

a naphthalimide derivative, a disazomethine derivative: RCH═N—N═CHR, or mixture of these compounds. Some specific examples include Solvent Green 7 (pyranine), Acid Yellow 184 (a coumarin derivative), Acid Yellow 250 (a coumarin derivative), Yellow 101, Basic Yellow 40 (a coumarin derivative), Solvent Yellow 43 (a naphthalimide derivative), Solvent Yellow 44 (a naphthalimide derivative), Solvent Yellow 85 (a naphthalimide derivative), Solvent Yellow 145 (a coumarin derivative), Solvent Yellow 160:1 (a coumarin derivative), and combinations thereof.

In other examples of the multi-functional agent, the hydrophobic component is the paraffin wax. In these examples, the paraffin wax has from 15 carbon atoms to 200 carbon atoms.

The paraffin wax may be any paraffin wax (having from 15 carbon atoms to 200 carbon atoms) that is capable of being 3D printed. Some examples of suitable paraffin wax(es) include microcrystalline paraffin waxes, polyethylene waxes, liquid paraffin waxes, refined paraffin waxes, and semi-refined paraffin waxes. When used in the multi-functional agent disclosed herein, it has been found that the paraffin wax can effectively intermingle with the build material particles (after being printed thereon), without inhibiting the function of the energy absorber in the multi-functional agent. The paraffin wax becomes embedded in the coalesced build material, which results in a hydrophobic 3D printed layer.

In one example, the paraffin wax is a paraffin-based wax emulsion, commercially available from BYK-Chemie GmbH as AQUACER™ 497.

In an example, the paraffin wax has an average particle size ranging from about 100 nm to about 400 nm. In another example, the paraffin wax has an average particle size ranging from about 200 nm to about 300 nm.

In an example, the paraffin wax may be incorporated into the aqueous vehicle of the multi-functional agent as a paraffin wax dispersion. The paraffin wax may be dispersed in water alone or in combination with a water-soluble or water-miscible organic co-solvent. The water-soluble or water-miscible organic co-solvents described in reference to the aqueous vehicle of the multi-functional agent also suitable for use in the paraffin wax dispersion. It is to be understood, however, that in this example, the liquid components of the paraffin wax dispersion become part of the aqueous vehicle of the multi-functional agent.

The amount of the paraffin wax in the dispersion may range from about 20 wt % to about 60 wt %, based on a total weight of the paraffin wax dispersion. The paraffin wax may then be incorporated into the multi-functional agent aqueous vehicle so that the paraffin wax is present in an active amount that is suitable (i) for generating a part with the desired properties and (ii) for the printing architecture that is to be used. In some examples, the paraffin wax is present (in the multi-functional agent) in a total amount ranging from about 5 wt % active to about 20 wt % active, based on the total weight of the multi-functional agent. In other examples, the paraffin wax is present in a total amount ranging from about 7.5 wt % active to about 17.5 wt % active, or from about 10 wt % active to about 20 wt % active, or from about 12.5 wt % active to about 17.5 wt % active, or from about 14 wt % active to about 16 wt % active, based on the total weight of the multi-functional agent. In one example, the paraffin wax is present (in the multi-functional agent) in a total amount of about 15.0 wt % active.

In examples of the multi-functional agent where the hydrophobic component is the paraffin wax, the energy absorber is selected from the group consisting of an infrared radiation absorbing self-dispersed pigment, an infrared radiation absorbing dye, and an ultraviolet radiation absorber.

In these examples, the energy absorber may be the infrared radiation absorbing self-dispersed pigment. The dispersant attached to the surface of these self-dispersed pigments render them compatible with the paraffin wax. By “compatible,” it is meant that the paraffin wax does not agglomerate (or cause the other components of the energy absorbing composition to agglomerate) when in the presence of the self-dispersed pigment. A suitable example of the infrared radiation absorbing self-dispersed pigment includes CAB-O-JET® 400 (available from Cabot).

In examples of the multi-functional agent where the hydrophobic component is the paraffin wax, the energy absorber may also be the infrared radiation absorbing dye. The infrared absorbing dyes described in reference to examples of the multi-functional agent where the hydrophobic component is the perfluorinated polymer are also suitable for use in examples of the multi-functional agent where the hydrophobic component is the paraffin wax. Further, the hydrophobic near-infrared absorbing dyes described in reference to examples of the multi-functional agent where the hydrophobic component is the perfluorinated polymer are also suitable for use in examples of the multi-functional agent where the hydrophobic component is the paraffin wax.

The energy absorber (in examples of the multi-functional agent where the hydrophobic component is the paraffin wax) may also be the ultraviolet (UV) radiation absorber. The UV radiation absorbers described in reference to examples of the multi-functional agent where the hydrophobic component is the perfluorinated polymer are also suitable for use in examples of the multi-functional agent where the hydrophobic component is the paraffin wax.

In any example of the multi-functional agent (e.g., where the hydrophobic component is the perfluorinated polymer or the paraffin wax), the energy absorber may be incorporated into the aqueous vehicle (of the multi-functional agent) as an energy absorber dispersion. The energy absorber may be dispersed in water alone or in combination with a water-soluble or water-miscible organic co-solvent. Suitable water-soluble or water-miscible organic co-solvents are described herein in reference to the multi-functional agent aqueous vehicle. It is to be understood, however, that in these examples, the liquid components of the energy absorber dispersion become part of the aqueous vehicle of the multi-functional agent. Some examples of the energy absorber dispersion (e.g., those including a non-self-dispersed pigment) may include a dispersant present in a weight ratio with respect to the energy absorber of 1:5 to 1:10. Examples of a suitable dispersant are set forth herein in reference to the coloring agent.

The amount of the energy absorber in the dispersion may range from about 10 wt % to about 50 wt %, based on a total weight of the energy absorber dispersion. The energy absorber dispersion may then be incorporated into the multi-functional agent aqueous vehicle so that the energy absorber is present in an active amount that is suitable (i) for generating a part with the desired properties and (ii) for the printing architecture that is to be used. In some examples, the energy absorber is present (in the multi-functional agent) in a total amount ranging from about 0.01 wt % active to about 20 wt % active, based on the total weight of the multi-functional agent. In other examples, the energy absorber is present in a total amount ranging from about 0.1 wt % active to about 10 wt % active, or from about 0.1 wt % active to about 5 wt % active, based on the total weight of the multi-functional agent. In one example, the energy absorber is present in a total amount of about 2.5 wt % active.

It is believed that these example energy absorber loadings allow the multi-functional agent to have good jettability and efficient heat/radiation absorbance, without interfering with the hydrophobic component of the multi-functional agent.

In other examples of the multi-functional agent (e.g., where the energy absorber is the infrared radiation absorbing dye, or the visible radiation absorbing dye, or is the UV radiation absorber), the energy absorber may be added to the multi-functional agent in solid form (e.g., not in a dispersion).

In some examples, the multi-functional agent consists of the aqueous vehicle; the hydrophobic component; and the energy absorber (with no other components). In other examples, the multi-functional agent further includes an additive selected from the group consisting of a humectant, an anti-kogation agent, a surfactant, and combinations thereof. The additive may be mixed with the aqueous vehicle of the multi-functional agent.

The multi-functional agent may include the humectant. An example of a suitable humectant is ethoxylated glycerin having the following formula:

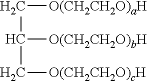

in which the total of a+b+c ranges from about 5 to about 60, or in other examples, from about 20 to about 30. An example of the ethoxylated glycerin is LIPONIC® EG-1 (LEG-1, glycereth-26, a+b+c=26, available from Vantage Specialty Chemicals). Another example of a suitable humectant is glycol ether (available from The Dow Chemical Company as DOWANOL™ TPM). Yet another example of a suitable humectant is propylene glycol.

In an example, the total amount of the humectant present in the multi-functional agent ranges from about 1 wt % active to about 20 wt % active, or from about 5 wt % active to about 17.5 wt % active, or from about 10 wt % active to about 17.5 wt % active, or from about 12.5 wt % active to about 17.5 wt % active, based on the total weight of the multi-functional agent. In one example, the humectant is present in the multi-functional agent in a total amount of about 15.0 wt % active.

The multi-functional agent may further include the anti-kogation agent. Kogation refers to the deposit of dried printing liquid (e.g., the multi-functional agent) on a heating element of a thermal inkjet printhead. Anti-kogation agent(s), when used, is/are included to assist in preventing the buildup of kogation.

Examples of suitable anti-kogation agents include oleth-3-phosphate (commercially available as CRODAFOS™ O3A or CRODAFOS™ N-3A) or dextran 500k. Other suitable examples of the anti-kogation agents include CRODAFOS™ HCE (phosphate-ester from Croda Int.), CRODAFOS® 010A (oleth-10-phosphate from Croda Int.), or DISPERSOGEN® LFH (polymeric dispersing agent with aromatic anchoring groups, acid form, anionic, from Clariant), etc. It is to be understood that any combination of the anti-kogation agents listed may be used.

The anti-kogation agent may be present in the multi-functional agent in a total amount ranging from about 0.1 wt % active to about 1.5 wt % active, based on the total weight of the multi-functional agent. In one example, the anti-kogation agent is present in a total amount of about 0.5 wt % active, based on the total weight of the multi-functional agent.

The multi-functional agent may further include the surfactant. Suitable surfactant(s) for the multi-functional agent include non-ionic, cationic, or anionic surfactants. Some example surfactants include alkyl polyethylene oxides, alkyl phenyl polyethylene oxides, polyethylene oxide block copolymers, acetylenic polyethylene oxides, polyethylene oxide (di)esters, polyethylene oxide amines, protonated polyethylene oxide amines, protonated polyethylene oxide amides, dimethicone copolyols, substituted amine oxides, fluorosurfactants, combinations thereof. Some specific examples include a self-emulsifiable, non-ionic wetting agent based on acetylenic diol chemistry (e.g., SURFYNOL® SEF from Evonik Degussa), a non-ionic fluorosurfactant (e.g., CAPSTONE® fluorosurfactants, such as CAPSTONE® FS-35, from Chemours), an ethoxylated low-foam wetting agent (e.g., SURFYNOL® 440 or SURFYNOL® CT-111 from Evonik Degussa), an ethoxylated wetting agent and molecular defoamer (e.g., SURFYNOL® 420 from Evonik Degussa), non-ionic wetting agents and molecular defoamers (e.g., SURFYNOL® 104E from Evonik Degussa), and/or water-soluble, non-ionic surfactants (e.g., TERGITOL™ TMN-6, TERGITOL™ 15-S-7, or TERGITOL™ 15-S-9) (a secondary alcohol ethoxylate) from The Dow Chemical Company or TEGO® Wet 510 (organic surfactant) available from Evonik Degussa). Yet another suitable (anionic) surfactant includes alkyldiphenyloxide disulfonate (e.g., the DOWFAX™ series, such a 2A1, 3B2, 8390, C6L, C10L, and 30599, from The Dow Chemical Company).

Whether a single surfactant is used or a combination of surfactants is used, the total amount of surfactant in the multi-functional agent may range from about 0.01 wt % active to about 1 wt % active, based on the total weight of the multi-functional agent. In another example, the total amount of surfactant(s) in the multi-functional agent may range from about 0.05 wt % active to about 0.9 wt % active, or from about 0.1 wt % active to about 0.8 wt % active, or from about 0.25 wt % active to about 0.75 wt % active, or from about 0.3 wt % active to about 0.7 wt % active, or from about 0.4 wt % active to about 0.6 wt % active, based on the total weight of the multi-functional agent. In one example, the total amount of surfactant(s) in the multi-functional agent is about 0.75 wt % active.

The balance of any example of the multi-functional agent is the water (e.g., deionized water, purified water, etc.). The amount of water may vary depending upon the amounts of the other components in the multi-functional agent. In one example, the multi-functional agent is jettable via a thermal inkjet printhead, and includes from about 50 wt % to about 90 wt % water.

### Detailing Agent

Any example of the 3D printing methods described herein may utilize a detailing agent. The detailing agent may include a surfactant, a co-solvent, and a balance of water. In an example, the detailing agent consists of these components and no other components. In another example, the detailing agent further includes additional components, such as anti-kogation agent(s) (which is/are described above in reference to the multi-functional agent), chelating agent(s), antimicrobial agent(s), or combinations thereof.

The surfactant(s) that may be used in the detailing agent include any of the non-ionic, anionic, and cationic surfactant additives listed herein in reference to the multi-functional agent. The total amount of surfactant(s) in the detailing agent may range from about 0.1 wt % active to about 5 wt % active, based on a total weight of the detailing agent.

The co-solvent(s) that may be used in the detailing agent include any of the co-solvents listed above in reference to the aqueous vehicle of the multi-functional agent. The total amount of the co-solvent(s) present in the detailing agent may range from about 1 wt % active to about 65 wt % active, based on the total weight of the detailing agent.

Suitable chelating agents that may be used in the detailing agent include methylglycinediacetic acid, trisodium salt; 4,5-dihydroxy-1,3-benzenedisulfonic acid disodium salt monohydrate; ethylenediaminetetraacetic acid (EDTA); hexamethylenediamine tetra(methylene phosphonic acid), potassium salt; and combinations thereof. Methylglycinediacetic acid, trisodium salt (Na3MGDA) is commercially available as TRILON® M from BASF Corp. 4,5-dihydroxy-1,3-benzenedisulfonic acid disodium salt monohydrate is commercially available as TIRON™ monohydrate. Hexamethylenediamine tetra(methylene phosphonic acid), potassium salt is commercially available as DEQUEST® 2054 from Italmatch Chemicals. Whether a single chelating agent is used or a combination of chelating agents is used, the total amount of chelating agent(s) in the detailing agent may range from greater than 0 wt % active to about 0.5 wt % active, based on the total weight of the detailing agent.

Antimicrobial agents are also known as biocides and/or fungicides. Examples of suitable antimicrobial agents that may be used in the detailing agent include the NUOSEPT® (Ashland Inc.), UCARCIDE™ or KORDEK™ or ROCIMA™ (The Dow Chemical Company), PROXEL® (Arch Chemicals) series, ACTICIDE® B20 and ACTICIDE® M20 and ACTICIDE® MBL (blends of 2-methyl-4-isothiazolin-3-one (MIT), 1,2-benzisothiazolin-3-one (BIT) and Bronopol) (Thor Chemicals), AXIDE™ (Planet Chemical), NIPACIDE™ (Clariant), blends of 5-chloro-2-methyl-4-isothiazolin-3-one (CIT or CMIT) and MIT under the tradename KATHON™ (The Dow Chemical Company), and combinations thereof.

In an example, the detailing agent may include a total amount of antimicrobial agent(s) ranging from about 0.0001 wt % active to about 1 wt % active. In an example, the antimicrobial agent(s) is/are a biocide(s) and is/are present in the detailing agent in an amount ranging from about 0.25 wt % active to about 0.35 wt % active (based on the total weight of the detailing agent).

Some examples of the detailing agent disclosed herein do not include a colorant. As such, the detailing agent may be colorless. As used herein, “colorless” means that the detailing agent is achromatic and does not include a colorant.

Other examples of the detailing agent include a colorant that does not substantially absorb the fusing radiation. For example, when the energy absorber is to be fused using near-infrared radiation, the colorant in the detailing agent may be a dye that is capable of absorbing radiation with wavelengths of 400 nm to 650 nm but not wavelengths of 780 nm to 2500 nm. In this example, the colorant (when included in the detailing agent) absorbs at least some wavelengths within the visible spectrum, but absorbs little or no wavelengths within the near-infrared spectrum. This is in contrast to at least some examples of the energy absorber in the multi-functional agent, which absorb wavelengths within the near-infrared spectrum and/or the infrared spectrum and/or ultraviolet spectrum. As such, the colorant in the detailing agent (when included) will not substantially absorb the fusing radiation, and thus will not initiate coalescing/fusing of the build material composition in contact therewith when the build material composition is exposed to energy.

The balance of the detailing agent is water. As such, the amount of water in the detailing agent may vary depending upon the amounts of the other components that are included. The water may be deionized water or purified water.

### Coloring Agent

Some examples of the 3D printing methods described herein utilize a coloring agent. The coloring agent may include a colorant, a co-solvent, and a balance of water. In some examples, the coloring agent consists of these components, and no other components.

In other examples, the coloring agent may further include additional components that aid in dispersability and/or ink jettability. Some examples of additional coloring agent components include dispersant(s) (e.g., a water-soluble acrylic acid polymer (e.g., CARBOSPERSE® K7028 available from Lubrizol), water-soluble styrene-acrylic acid copolymers/resins (e.g., JONCRYL® 296, JONCRYL® 671, JONCRYL® 678, JONCRYL® 680, JONCRYL® 683, JONCRYL® 690, etc. available from BASF Corp.), and a high molecular weight block copolymer with pigment affinic groups (e.g., DISPERBYK®-190 available BYK Additives and Instruments) or water-soluble styrene-maleic anhydride copolymers/resins. Other additional coloring agent components include humectant(s), surfactant(s), anti-kogation agent(s), and/or antimicrobial(s) (examples of which are described herein in reference to the multi-functional agent and/or the detailing agent).

The coloring agent may be a black agent, a cyan agent, a magenta agent, or a yellow agent. As such, the coloring agent may be a black colorant, a cyan colorant, a magenta colorant, a yellow colorant, or a combination of colorants that together achieve a black, cyan, magenta, or yellow color. While some examples have been provided, it is to be understood that other colored inks may also be used. The colorant of the coloring agent may be any pigment or dye.

In some instances, the colorant of the coloring agent may be transparent to infrared wavelengths and/or ultraviolet wavelengths. In other instances, the colorant of the coloring agent may not be completely transparent to infrared and/or ultraviolet wavelengths, but does not absorb enough radiation to sufficiently heat the build material composition in contact therewith. In an example, the colorant absorbs less than 10% of radiation having wavelengths in a range of 100 nm to 400 nm and/or 650 nm to 2500 nm. In another example, the colorant absorbs less than 20% of radiation having wavelengths in a range of 650 nm to 4000 nm.

The colorant of the coloring agent is also capable of absorbing radiation with wavelengths of 400 nm to 650 nm. As such, the colorant absorbs at least some wavelengths within the visible spectrum, but absorbs little or no wavelengths within the near-infrared spectrum and/or ultraviolet spectrum. This is in contrast to at least some examples of the energy absorber in the multi-functional agent, which absorb wavelengths within the near-infrared spectrum and/or the infrared spectrum and/or ultraviolet spectrum. As such, the colorant in the coloring agent will not substantially absorb the fusing radiation, and thus will not initiate coalescing/fusing of the build material composition in contact therewith when the build material composition is exposed to energy.

In other examples, the colorant may be any azo dye having sodium or potassium counter ion(s) or any diazo (i.e., double azo) dye having sodium or potassium counter ion(s).

An example of the pigment based coloring agent may include from about 1 wt % to about 10 wt % of pigment(s), from about 10 wt % to about 30 wt % of co-solvent(s), from about 0.1 wt % to about 10 wt % of dispersant(s), from about 0.1 wt % to about 5 wt % of binder(s), from 0.01 wt % to about 1 wt % of anti-kogation agent(s), from about 0.05 wt % to about 0.1 wt % antimicrobial agent(s), and a balance of water. An example of the dye based coloring agent may include from about 1 wt % to about 7 wt % of dye(s), from about 10 wt % to about 30 wt % of co-solvent(s), from about 0.05 wt % to about 0.1 wt % antimicrobial agent(s), from 0.05 wt % to about 0.1 wt % of chelating agent(s), from about 0.005 wt % to about 0.2 wt % of buffer(s), and a balance of water.

Some examples of the coloring agent include a set of cyan, magenta, and yellow agents, such as C1893A (cyan), C1984A (magenta), and C1985A (yellow); or C4801A (cyan), C4802A (magenta), and C4803A (yellow); all of which are available from HP Inc. Other commercially available coloring agents 18 include C9384A (printhead HP 72), C9383A (printhead HP 72), C4901A (printhead HP 940), and C4900A (printhead HP 940).

### Build Material Composition

The multi-functional agent described herein may be suitable for printing on a polymeric build material composition. Some examples of suitable polymeric materials for the polymeric build material composition include polyamides, polyacetals, polyolefins, styrene polymers and copolymers, fluoropolymers, acrylic polymers and copolymers, polyethers, polyaryletherketones, polyesters (e.g., a thermoplastic copolyester (TPC)), polycarbonates (PC), a thermoplastic polyurethane (TPU), a thermoplastic polyolefin elastomer (TPO), a thermoplastic vulcanizate (TPV), a polyether block amide (PEBA), or a combination thereof. In an example, the polymer material is selected from the group consisting of polyethylene, polyethylene terephthalate (PET), polystyrene (PS), polypropylene, polyoxymethylene (POM), polyether ether ketone (PEEK), polyetherketoneketone (PEKK), polyphenylene sulfide (PPS), polytetrafluoroethylene (PTFE), polyvinylidene fluoride (PVDF), acrylonitrile styrene acrylate (ASA), poly(methyl methacrylate) (PMMA), styrene acrylonitrile (SAN), styrene maleic anhydride (SMA), poly(vinyl chloride) (PVC), polyethylenimine (PEI), and combinations thereof.

In some examples, the polymeric build material composition is a polyamide build material composition including polyamide particles. Examples of suitable polyamides include polyamide-11 (PA 11/nylon 11), polyamide-12 (PA 12/nylon 12), polyamide-6 (PA 6/nylon 6), polyamide-8 (PA 8/nylon 8), polyamide-9 (PA 9/nylon 9), polyamide-66 (PA 66/nylon 66), polyamide-612 (PA 612/nylon 612), polyamide-812 (PA 812/nylon 812), polyamide-912 (PA 912/nylon 912), etc.), a thermoplastic polyamide (TPA), and combinations thereof.

Any of the polymeric materials in the build material composition may be in the form of a powder or a powder-like material. The powder-like material includes, for example, short fibers having a length that is greater than its width. In some examples, the powder or powder-like material may be formed from, or may include, short fibers that may, for example, have been cut into short lengths from long strands or threads of material.

The polymeric material may be made up of similarly sized particles and/or differently sized particles. In an example, the average particle size of the polymeric material ranges from about 2 μm to about 225 μm. In another example, the average particle size of the polymeric material ranges from about 10 μm to about 130 μm.

When the build material composition includes crystalline or semi-crystalline polymeric material, the build material composition may have a wide processing window of greater than 5 °C, which can be defined by the temperature range between the melting point and the re-crystallization temperature. In an example, the polymeric material in the build material composition may have a melting point ranging from about 50 °C to about 300 °C. As other examples, the polymeric material in the build material composition may have a melting point ranging from about 155 °C to about 225 °C, from about 155 °C to about 215 °C, about 160 °C to about 200 °C, from about 170 °C to about 190 °C, or from about 182 °C to about 189 °C. As still another example, the polymeric material in the build material composition may have a melting point of about 180 °C.

When the build material composition includes thermoplastic polymeric material, the build material composition may have a melting range within the range of from about 130 °C to about 250 °C.

In some examples, the build material composition does not substantially absorb radiation having a wavelength within the range of 300 nm to 1400 nm. The phrase “does not substantially absorb” means that the absorptivity of the build material composition at a particular wavelength is 25% or less (e.g., 20%, 10%, 5%, etc.).

In some examples, in addition to the polymeric material, the build material composition may include an antioxidant, a whitener, an antistatic agent, a flow aid, or a combination thereof. While several examples of these additives are provided, it is to be understood that these additives are selected to be thermally stable (i.e., will not decompose) at the 3D printing temperatures.

Antioxidant(s) may be added to the build material composition to prevent or slow molecular weight decreases of the polymeric material and/or to prevent or slow discoloration (e.g., yellowing) by preventing or slowing oxidation of the polymeric material. In some examples, the polymeric material may discolor upon reacting with oxygen, and this discoloration may contribute to the discoloration of the build material composition. The antioxidant may be selected to minimize discoloration. In some examples, the antioxidant may be a radical scavenger. In these examples, the antioxidant may include IRGANOX®1098 (benzenepropanamide, N,N′-1,6-hexanediylbis(3,5-bis(1,1-dimethylethyl)-4-hydroxy)), IRGANOX®254 (a mixture of 40% triethylene glycol bis(3-tert-butyl-4-hydroxy-5-methylphenyl), polyvinyl alcohol and deionized water), and/or other sterically hindered phenols. In other examples, the antioxidant may include a phosphite and/or an organic sulfide (e.g., a thioester). The antioxidant may be in the form of fine particles (e.g., having an average particle size of 5 μm or less) that are dry blended with the polymeric material. In an example, the antioxidant may be included in the build material composition in a total amount ranging from about 0.01 wt % to about 5 wt %, based on a total weight of the build material composition. In other examples, the antioxidant may be included in the build material composition in a total amount ranging from about 0.01 wt % to about 2 wt % or from about 0.2 wt % to about 1 wt %, based on the total weight of the build material composition.

Whitener(s) may be added to the build material composition to improve visibility. Examples of suitable whiteners include titanium dioxide (TiO₂), zinc oxide (ZnO), calcium carbonate (CaCO₃), zirconium dioxide (ZrO₂), aluminum oxide (Al₂O₃), silicon dioxide (SiO₂), boron nitride (BN), and combinations thereof. In some examples, a stilbene derivative may be used as the whitener and a brightener. In these examples, the temperature(s) of the 3D printing process may be selected so that the stilbene derivative remains stable (i.e., the 3D printing temperature does not thermally decompose the stilbene derivative). In an example, any example of the whitener may be included in the build material composition in a total amount ranging from greater than 0 wt % to about 10 wt %, based on the total weight of the build material composition.

Antistatic agent(s) may be added to the build material composition to suppress tribo-charging. Examples of suitable antistatic agents include aliphatic amines (which may be ethoxylated), aliphatic amides, quaternary ammonium salts (e.g., behentrimonium chloride or cocamidopropyl betaine), esters of phosphoric acid, polyethylene glycolesters, or polyols. Some suitable commercially available antistatic agents include HOSTASTAT® FA 38 (natural based ethoxylated alkylamine), HOSTASTAT® FE2 (fatty acid ester), and HOSTASTAT® HS 1 (alkane sulfonate), each of which is available from Clariant Int. Ltd.). In an example, the antistatic agent is added in a total amount ranging from greater than 0 wt % to less than 5 wt %, based on the total weight of the build material composition.

Flow aid(s) may be added to improve the coating flowability of the build material composition. Flow aids may be particularly beneficial when the polymeric material in the build material composition has an average particle size less than 25 μm. The flow aid improves the flowability of the build material composition by reducing the friction, the lateral drag, and the tribocharge buildup (by increasing the particle conductivity). Examples of suitable flow aids include aluminum oxide (Al₂O₃), tricalcium phosphate (E341), powdered cellulose (E460(ii)), magnesium stearate (E470b), sodium bicarbonate (E500), sodium ferrocyanide (E535), potassium ferrocyanide (E536), calcium ferrocyanide (E538), bone phosphate (E542), sodium silicate (E550), silicon dioxide (E551), calcium silicate (E552), magnesium trisilicate (E553a), talcum powder (E553b), sodium aluminosilicate (E554), potassium aluminum silicate (E555), calcium aluminosilicate (E556), bentonite (E558), aluminum silicate (E559), stearic acid (E570), and polydimethylsiloxane (E900). In an example, the flow aid is added in a total amount ranging from greater than 0 wt % to less than 5 wt %, based on the total weight of the build material composition.

### Method of Printing

Examples of a printing method 100, which utilize the multi-functional agent, will now be described.

A method 100 for printing a hydrophobic three-dimensional (3D) object includes: applying a polymeric build material to form a build material layer; based on a 3D object model, selectively applying a multi-functional agent onto at least a portion of the build material layer, the multi-functional agent including: an aqueous vehicle; a hydrophobic component dispersed in the aqueous vehicle, the hydrophobic component being selected from the group consisting of a perfluorinated polymer and a paraffin wax; and an energy absorber dispersed in the aqueous vehicle; and exposing the build material layer to energy to selectively coalesce the at least the portion.

Prior to execution of any examples of the method 100, it is to be understood that a controller may access data stored in a data store pertaining to a 3D part/object that is to be printed. For example, the controller may determine the number of layers of a build material composition that are to be formed, the locations at which the multi-functional agent is to be deposited on each of the respective layers, etc.

It is to be understood that any example of the multi-functional agent disclosed herein may be used in the method 100.

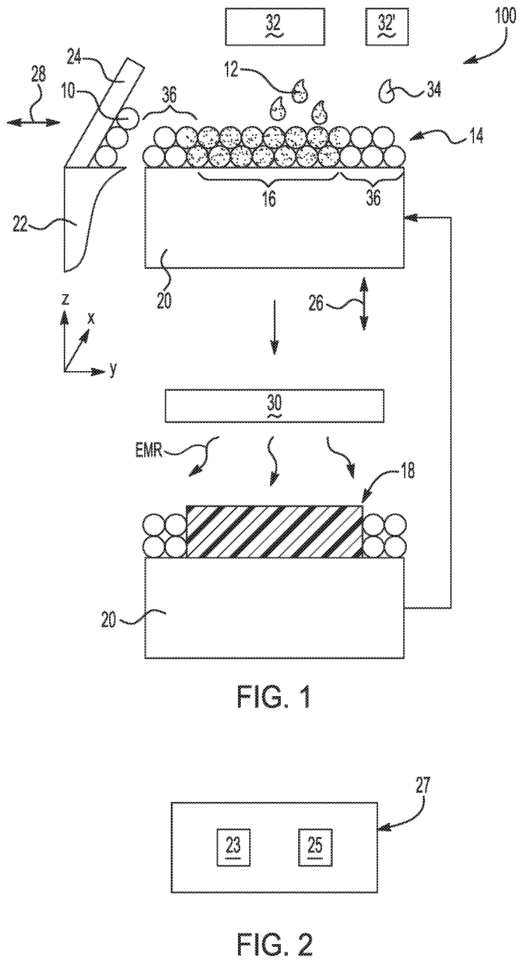

An example of the method 100 is shown schematically in FIG. 1. In FIG. 1, a layer 14 of the build material composition 10 is applied on a build area platform 20. It is to be understood that any of the build materials described herein may be used in the build material composition 10 in the method 100. A printing system may be used to apply the build material composition 10. The printing system may include the build area platform 20, a build material supply 22 containing the build material composition 10, and a build material distributor 24.

The build area platform 20 receives the build material composition 10 from the build material supply 22. The build area platform 20 may be moved in the directions as denoted by the arrow 26, e.g., along the z-axis, so that the build material composition 10 may be delivered to the build area platform 20 or to a previously formed layer 14. In an example, when the build material composition 10 is to be delivered, the build area platform 20 may be programmed to advance (e.g., downward) enough so that the build material distributor 24 can push the build material composition 10 onto the build area platform 20 to form a substantially uniform layer 14 of the build material composition 10 thereon. The build area platform 20 may also be returned to its original position, for example, when a new part is to be built.

The build material supply 22 may be a container, bed, or other surface that is to position the build material composition 10 between the build material distributor 24 and the build area platform 20. The build material supply 22 may include heaters so that the build material composition 10 is heated to a supply temperature ranging from about 25 °C to about 150 °C. In these examples, the supply temperature may depend, in part, on the build material composition 10 used and/or the 3D printer used. As such, the range provided is one example, and higher or lower temperatures may be used.

The build material distributor 24 may be moved in the directions as denoted by the arrow 28, e.g., along the y-axis, over the build material supply 22 and across the build area platform 20 to spread the layer 14 of the build material composition 10 over the build area platform 20. The build material distributor 24 may also be returned to a position adjacent to the build material supply 22 following the spreading of the build material composition 10. The build material distributor 24 may be a blade (e.g., a doctor blade), a roller, a combination of a roller and a blade, and/or any other device capable of spreading the build material composition 10 over the build area platform 20. For instance, the build material distributor 24 may be a counter-rotating roller. In some examples, the build material supply 22 or a portion of the build material supply 22 may translate along with the build material distributor 24 such that build material composition 10 is delivered continuously to the build area platform 20 rather than being supplied from a single location at the side of the printing system as depicted in FIG. 1.

The build material supply 22 may supply the build material composition 10 into a position so that it is ready to be spread onto the build area platform 20. The build material distributor 24 may spread the supplied build material composition 10 onto the build area platform 20. The controller (not shown) may process “control build material supply” data, and in response, control the build material supply 22 to appropriately position the particles of the build material composition 10, and may process “control spreader” data, and in response, control the build material distributor 24 to spread the build material composition 10 over the build area platform 20 to form the layer 14. In FIG. 1, one build material layer 14 has been formed.

The layer 14 has a substantially uniform thickness across the build area platform 20. In an example, the build material layer 14 has a thickness ranging from about 50 μm to about 120 μm. In another example, the thickness of the build material layer 14 ranges from about 30 μm to about 300 μm. It is to be understood that thinner or thicker layers may also be used. For example, the thickness of the build material layer 14 may range from about 20 μm to about 500 μm. The layer thickness may be about 2× (i.e., 2 times) the average diameter of the polymeric material at a minimum for finer part definition. In some examples, the layer 14 thickness may be about 1.2x the average diameter of the polymeric material in the build material composition 10.

After the build material composition 10 has been applied, and prior to further processing, the build material layer 14 may be exposed to heating. In an example, the heating temperature may be below the melting point or melting range of the polymeric material in the build material composition 10. As examples, the pre-heating temperature may range from about 5 °C to about 50 °C below the melting point or the lowest temperature of the melting range of the polymeric material. In an example, the pre-heating temperature ranges from about 50 °C to about 205 °C. In still another example, the pre-heating temperature ranges from about 100 °C to about 190 °C. It is to be understood that the pre-heating temperature may depend, in part, on the build material composition 10 used. As such, the ranges provided are some examples, and higher or lower temperatures may be used.

Pre-heating the layer 14 may be accomplished by using any suitable heat source that exposes all of the build material composition 10 in the layer 14 to the heat. Examples of the heat source include a thermal heat source (e.g., a heater (not shown) integrated into the build area platform 20 (which may include sidewalls)) or a radiation source 30.

After the layer 14 is formed, and in some instances is pre-heated, the multi-functional agent 12 is selectively applied on at least some of the build material composition 10 in the layer 14 to form a patterned portion 16. It is to be understood that because the multi-functional agent 12 includes the hydrophobic component, any portion (e.g., patterned portion 16) of the layer 14 of the build material composition 10 that is patterned with the multi-functional agent 12 will become a hydrophobic layer 18 of a 3D object.

The amount of the multi-functional agent 12 that is applied per unit of the build material composition 10 in the patterned portion 16 may be sufficient to absorb and convert enough electromagnetic radiation so that the build material composition 10 in the patterned portion 16 will coalesce/fuse. The amount of the multi-functional agent 12 that is applied per unit of the build material composition 10 may depend, at least in part, on the energy absorber used, the energy absorber loading in the multi-functional agent 12, and the polymeric material in the build material composition 10. In particular, the concentration of the energy absorber in the multi-functional agent 12 can be considered. This concentration can be used to determine how much multi-functional agent 12 to apply to achieve a weight ratio of multi-functional agent 12 to build material composition 10 for acceptable layer-by-layer fusing. Thus, if applying the multi-functional agent 12 (10%) to the build material composition 10 (90%) at about a 1:9 mass ratio, then the energy absorber to build material composition 10 mass ratio (as applied) can be from about 1:9000 to about 1:4.5. If more (up to 20%) or less (down to 5%) of the multi-functional agent 12 is applied to the build material composition 10, then these mass ratios can be adjusted accordingly. That stated, the mass ratio of the energy absorber to the build material composition 10 (as applied) in some more specific examples can be from about 1:1000 to about 1:80, from about 1:800 to about 1:100, or from about 1:200 to about 1:5, for example.

The multi-functional agent 12 may be dispensed from an applicator 32. The applicator 32 may include a thermal inkjet printhead, a piezoelectric printhead, a continuous inkjet printhead, etc., and the selective application of the multi-functional agent 12 may be accomplished by thermal inkjet printing, piezo electric inkjet printing, continuous inkjet printing, etc. The controller may process data, and in response, control the applicator 32 to deposit the multi-functional agent 12 onto pre-determined portion(s) of the build material composition 10 to generate the patterned portion 16.

In some examples, the method 100 further comprises selectively applying, based on the 3D object model, a detailing agent 34 onto another portion of the build material layer 14 outside of the patterned portion 16. The other portion is shown at reference numeral 36 in FIG. 1. It is to be understood that any example of the detailing agent 34 disclosed herein may be used in the method 100.

As shown in FIG. 1, the detailing agent 34 may be selectively applied to the portion(s) 36 of the layer 14. The portion(s) 36 are not patterned with the multi-functional agent 12 and thus are not to become part of the hydrophobic layer 18 of the 3D object. Thermal energy generated during radiation exposure may propagate into the surrounding portion(s) 36 that do not have the multi-functional agent 12 applied thereto. The propagation of thermal energy may be inhibited, and thus the coalescence of the non-patterned build material portion(s) 36 may be prevented, when the detailing agent 34 is applied to these portion(s) 36.

The detailing agent 34 may be dispensed from an applicator 32′. The applicator 32′ may include a thermal inkjet printhead, a piezoelectric printhead, a continuous inkjet printhead, etc., and the selective application of the detailing agent 34 may be accomplished by thermal inkjet printing, piezo electric inkjet printing, continuous inkjet printing, etc. The controller may process data, and in response, control the applicator 32′ to deposit the detailing agent 34 onto pre-determined portion(s) of the build material composition 10 to generate the portion(s) 36.

It is to be understood that the selective application of any of the multi-functional agent 12 and/or the detailing agent 34 may be accomplished in a single printing pass or in multiple printing passes. In some examples, the agent(s) 12, 34 is/are selectively applied in a single printing pass. In some other examples, the agent(s) is/are selectively applied in multiple printing passes. In one of these examples, the number of printing passes ranges from 2 to 4. It may be desirable to apply the multi-functional agent 12 and/or the detailing agent 34 in multiple printing passes to increase the amount, e.g., of the energy absorber, etc. that is applied to the build material composition 10, to avoid liquid splashing, to avoid displacement of the build material composition 10, etc.

After the multi-functional agent 12 and/or detailing agent 34 are selectively applied in the specific portion(s) 16, 36 of the layer 14, the entire layer 14 of the build material composition 10 is exposed to electromagnetic radiation (shown as EMR in FIG. 1).

The electromagnetic radiation is emitted from the radiation source 30. The length of time the electromagnetic radiation is applied for, or energy exposure time, may be dependent, for example, on one or more of: characteristics of the radiation source 30; characteristics of the build material composition 10; and/or characteristics of the multi-functional agent 12. In an example, a single point of the build material layer 14 is exposed to electromagnetic radiation for a period of time ranging from 0.01 second to 1 second.

It is to be understood that the electromagnetic radiation exposure may be accomplished in a single radiation event or in multiple radiation events. In an example, the exposing of the build material composition 10 is accomplished in multiple radiation events. In a specific example, the number of radiation events ranges from 3 to 8. In still another specific example, the exposure of the build material composition 10 to electromagnetic radiation may be accomplished in 3 radiation events. It may be desirable to expose the build material composition 10 to electromagnetic radiation in multiple radiation events to counteract a cooling effect that may be brought on by the amount of the multi-functional agent 12 or detailing agent 34 that is applied to the build material layer 14. Additionally, it may be desirable to expose the build material composition 10 to electromagnetic radiation in multiple radiation events to sufficiently elevate the temperature of the build material composition 10 in the portion(s) 16 without over heating the build material composition 10 in the non-patterned portion(s) 36.

The multi-functional agent 12 enhances the absorption of the radiation, converts the absorbed radiation to thermal energy, and promotes the transfer of the thermal heat to the build material composition 10 in contact therewith. In an example, the multi-functional agent 12 sufficiently elevates the temperature of the build material composition 10 in the portion 16 to a temperature above the melting point or within the melting range of the polymeric material, allowing coalescing/fusing (e.g., thermal merging, melting, binding, etc.) of the build material composition 10 to take place. The application of the electromagnetic radiation forms the hydrophobic layer 18 of a 3D object.

In some examples, the electromagnetic radiation that is used depends upon the energy absorber in the multi-functional agent 12. In some examples, the electromagnetic radiation has a wavelength ranging from 800 nm to 4000 nm, or from 800 nm to 1400 nm, or from 800 nm to 1200 nm, and is used when the energy absorber in the multi-functional agent 12 is an infrared absorbing pigment or dye. In other examples, the electromagnetic radiation has a wavelength ranging from 100 nm to 400 nm, and is used when the energy absorber in the multi-functional agent 12 is an ultraviolet radiation absorber. In still other examples, the electromagnetic radiation has a wavelength ranging from 400 nm to 700 nm, and is used when the energy absorber in the multi-functional agent 12 is a visible radiation absorber. Radiation having wavelengths within the provided ranges may be substantially absorbed (e.g., 80% or more of the applied radiation is absorbed) by the multi-functional agent 12 and may heat the build material composition 10 in contact therewith, and may not be substantially absorbed (e.g., 25% or less of the applied radiation is absorbed) by the non-patterned build material composition 10 in portion(s) 36.

After the 3D object layer 40 is formed, additional layer(s) may be formed thereon to create an example of the 3D object. To form the next layer, additional build material composition 10 may be applied on the hydrophobic layer 18. The multi-functional agent 12 is then selectively applied on at least a portion of the additional build material composition 10, according to the 3D object model. The detailing agent 34 may be applied in any area (e.g., portion(s) 36) of the additional build material composition 10 where coalescence is not desirable. After the multi-functional agent 12 and/or detailing agent 34 is/are applied, the entire additional layer of the additional build material composition 10 is exposed to electromagnetic radiation in the manner described herein. The application of additional build material composition 10, the selective application of the multi-functional agent 12 and/or the detailing agent 34, and the electromagnetic radiation exposure may be repeated a predetermined number of cycles to form the final 3D object in accordance with the 3D object model. As such, some examples of the method 100 include repeating the applying of the build material composition 10, the selectively applying of the multi-functional agent 12 and/or the detailing agent 34, and the exposing, to form a predetermined number of 3D object layers and a 3D printed object.

The 3D objects generated using the multi-functional agent 12 are capable of exhibiting hydrophobic properties, due in part to the presence of the hydrophobic component in the multi-functional agent 12.

Color may be added during 3D printing or after the 3D object is generated by using the coloring agent (not shown). It is to be understood that any example of the coloring agent disclosed herein may be used in the method 100.

In one example, the method 100 further comprises selectively applying, based on the 3D object model, a coloring agent to the patterned portion 16. In this example, the coloring agent is applied to the build material composition 10 along with the multi-functional agent 12. In this example, the colorant of the coloring agent becomes embedded throughout the coalesced/fused build material composition 10 of the 3D object layers, e.g., layer 18.

In another example, the method 100 further comprises selectively applying, based on the 3D object model, a coloring agent to the hydrophobic layer 18 of a 3D object. In this example, the coloring agent is applied to the exterior surface of the hydrophobic layer 18 of a 3D object.

In the examples disclosed herein, a 3D object may be printed in any orientation. For example, the 3D object can be printed from bottom to top, top to bottom, on its side, at an angle, or any other orientation. The orientation of the 3D object can also be formed in any orientation relative to the layering of the build material composition 10. For example, the 3D object can be formed in an inverted orientation or on its side relative to the layering of the build material composition 10. The orientation of the build within each layer 14 can be selected in advance or even by the user at the time of printing, for example.

Printing with a Fusing Agent and a Hydrophobic Agent

### Fluid Set

Further described herein are examples of a fluid set 27 for 3D printing, which is schematically depicted in FIG. 2. As shown in FIG. 2, examples of the fluid set 27 include: a hydrophobic agent 23 including: a paraffin wax having a mean particle size ranging from about 100 nm to 400 nm; and an aqueous vehicle; and a fusing agent 25 including an energy absorber having absorption at visible light wavelengths, infrared radiation wavelengths, ultraviolet radiation wavelengths, or combinations thereof.

The hydrophobic agent 23 and the fusing agent 25 are further described hereinbelow.

### Hydrophobic Agent

The hydrophobic agent 23 includes the paraffin wax. The paraffin wax(es) described in reference to the multi-functional agent 12 are also suitable for use in examples of the hydrophobic agent 23. The hydrophobic agent 23 disclosed herein, when used in combination with the separate fusing agent 25, has been found to produce 3D printed layers having controlled hydrophobic portions.

In an example, the paraffin wax may be incorporated into the aqueous vehicle of the hydrophobic agent 23 as a paraffin wax dispersion. The paraffin wax may be dispersed in water alone or in combination with a water-soluble or water-miscible organic co-solvent. The water-soluble or water-miscible organic co-solvents described in reference to the aqueous vehicle of the multi-functional agent 12 are also suitable for use in the paraffin wax dispersion. It is to be understood, however, that in this example, the liquid components of the paraffin wax dispersion become part of the aqueous vehicle of the hydrophobic agent 23.

The amount of the paraffin wax in the dispersion may range from about 20 wt % to about 60 wt %, based on a total weight of the dispersion. The paraffin wax may then be incorporated into the aqueous vehicle of the hydrophobic agent 23 so that the paraffin wax is present in an active amount that is suitable (i) for generating a part with the desired properties and (ii) for the printing architecture that is to be used. In some examples, the paraffin wax is present (in the hydrophobic agent 23) in a total amount ranging from about 5 wt % active to about 20 wt % active, based on a total weight of the hydrophobic agent 23. In other examples, the paraffin wax is present in a total amount ranging from about 7.5 wt % active to about 17.5 wt % active, or from about 10 wt % active to about 20 wt % active, or from about 12.5 wt % active to about 17.5 wt % active, based on the total weight of the hydrophobic agent 23. In one example, the paraffin wax is present in a total amount of about 15.0 wt % active.

In another example, the paraffin wax is added to the hydrophobic agent 23 in liquid form (e.g., the paraffin wax may be melted and mixed into the hydrophobic agent 23).

The hydrophobic agent 23 further includes the aqueous vehicle. In examples of the hydrophobic agent 23, the aqueous vehicle is selected from the group consisting of water, a water-soluble or water-miscible organic co-solvent, and combinations thereof. Suitable water-soluble or water-miscible organic co-solvents are described herein in reference to the multi-functional agent 12. The water may be purified water or deionized water, and makes up the balance of the hydrophobic agent 23.

In some examples of the hydrophobic agent 23, the aqueous vehicle consists of the water and/or the water-soluble or water-miscible organic co-solvent(s), and no other components. In other examples of the hydrophobic agent 23, the aqueous vehicle further includes an additive selected from the group consisting of a humectant, an anti-kogation agent, a surfactant, and combinations thereof, each of which is described herein in reference to the multi-functional agent 12 and/or the detailing agent 34. Any of these additives may be used in the respective amounts set forth herein, except that the total weight is with respect to the hydrophobic agent 23.

An example of the hydrophobic agent 23 may include from about 10 wt % active to about 30 wt % active of humectant(s)/co-solvent(s), from about 0.01 wt % active to about 1 wt % active of anti-kogation agent(s), and from about 0.01 wt % active to about 5 wt % active of surfactant(s).

### Fusing Agent

Examples of the fusing agent 25 used in the fluid set 27 include an energy absorber having absorption at visible light wavelengths, infrared radiation wavelengths, ultraviolet radiation wavelengths, or combinations thereof.

In one example, the energy absorber absorbs visible light wavelengths. A suitable energy absorber that absorbs visible light wavelengths is a printing liquid formulation including carbon black. Examples of this printing liquid formulation are commercially known as CM997A, 516458, C18928, C93848, C93808, or the like, all of which are available from HP Inc. These examples are also capable of absorbing infrared radiation.

In another example, the energy absorber absorbs infrared radiation wavelengths. The infrared absorbing dye(s) and/or hydrophobic near-infrared absorbing dye(s) described in reference the multi-functional agent 12 are also suitable for use as infrared radiation absorbers in the fusing agent 25.

In still another example, the energy absorber absorbs ultraviolet (UV) radiation. The UV radiation absorbers described in reference to examples of the multi-functional agent are also suitable for use as UV absorbers in examples of the fusing agent 25.

The fusing agent 25 further includes a fusing agent vehicle. The fusing agent vehicle may refer to a liquid in which the energy absorber and/or the other components of the fusing agent 25 is/are dispersed or dissolved to form the fusing agent 25. A wide variety of fusing agent vehicles, including aqueous and non-aqueous vehicles, may be used in the fusing agent 25. In some examples, the fusing agent vehicle may include water alone or a non-aqueous solvent alone with no other components. In other examples, the fusing agent vehicle may include other components, depending, in part, upon the applicator that is to be used to dispense the fusing agent 25. Examples of other suitable fusing agent 25 components include co-solvent(s), humectant(s), surfactant(s), antimicrobial agent(s), anti-kogation agent(s), and/or chelating agent(s).

It is to be understood that any of the co-solvent(s), surfactant(s), humectant(s), anti-kogation agent(s), antimicrobial agent(s), and/or chelating agent(s) described herein for the multi-functional agent 12 or for the detailing agent 34 may be used in any examples of the fusing agent 25 in any of the amounts provided, except that the percentages will be with respect to a total weight of the fusing agent 25.

It is to be further understood that specific blends of surfactants may be included in the fusing agent 25. In other examples, a single non-ionic, cationic, or anionic surfactant may be included in the fusing agent 25.

In some examples of the fusing agent 25, the energy absorber may be incorporated into the vehicle (of the fusing agent) as an energy absorber dispersion. The energy absorber may be dispersed in water alone or in combination with a water-soluble or water-miscible organic co-solvent. Suitable water-soluble or water-miscible organic co-solvents are described herein in reference to the multi-functional agent 12. It is to be understood, however, that in these examples, the liquid components of the energy absorber dispersion become part of the vehicle of the fusing agent 25.

The amount of the energy absorber in the dispersion may range from about 10 wt % to about 50 wt %, based on a total weight of the dispersion. The energy absorber dispersion may then be incorporated into the fusing agent vehicle so that the energy absorber is present in an active amount that is suitable (i) for generating a part with the desired properties and (ii) for the printing architecture that is to be used. In some examples, the energy absorber is present (in the fusing agent 25) in a total amount ranging from about 0.01 wt % active to about 20 wt % active, based on the total weight of the fusing agent 25. In other examples, the energy absorber is present in a total amount ranging from about 0.1 wt % active to about 10 wt % active, or from about 0.1 wt % active to about 5 wt % active, based on the total weight of the fusing agent 25. In one example, the energy absorber is present in a total amount of about 10.0 wt % active.

It is believed that these energy absorber loadings allow the fusing agent 25 to have good jettability and efficient heat/radiation absorbance, without interfering with the functionality of the paraffin wax included in the hydrophobic agent 23.

The balance of the fusing agent 25 is water (e.g., deionized water, purified water, etc.), which as described herein, may vary depending upon the other components in the fusing agent 25.

### Method of Printing

Examples of a printing method which utilize the hydrophobic agent 23 and the fusing agent 25 will now be described.

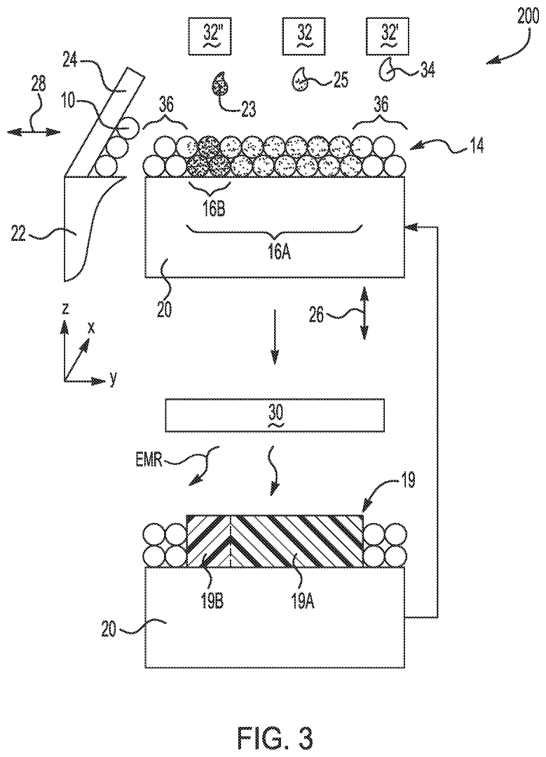

An example of a method 200 for printing a hydrophobic 3D object is shown schematically in FIG. 3. The method 200 includes: applying a polymeric build material to form a build material layer; based on a 3D object model, selectively applying a fusing agent 25 onto the build material layer, thereby forming a patterned portion; and a hydrophobic agent 23 onto at least a portion of the patterned portion, wherein the hydrophobic agent 23 includes a paraffin wax having a mean particle size ranging from about 50 nm to about 195 nm; and exposing the build material layer to energy to selectively coalesce the patterned portion.

It is to be understood that any example of the hydrophobic agent 23, the fusing agent 25, the detailing agent 34, the build material composition 10, and the coloring agent disclosed herein may be used in the method 200.

Prior to execution of any examples of the method 200, it is to be understood that a controller may access data stored in a data store pertaining to a 3D part/object that is to be printed. For example, the controller may determine the number of layers 14 of a build material composition 10 that are to be formed, the locations at which the hydrophobic agent 23 and the fusing agent 25 is/are to be deposited on each of the respective layers 14, etc.

In FIG. 3, a layer 14 of the build material composition 10 is applied on a build area platform 20. A printing system, such as that described in reference to FIG. 1, may be used to apply the build material composition 10 in the method 200. As described in reference to FIG. 1, the printing system may include the build area platform 20, a build material supply 22 containing the build material composition 10, a build material distributor 24, and one or more heaters. In the method 200, the build material composition 10 may be delivered, spread, and pre-heated as described in reference to FIG. 1.

After the layer 14 is formed, and in some instances is pre-heated, the fusing agent 25 is selectively applied on at least some of the build material composition 10 in the layer 14. It is to be understood that the fusing agent 25 is applied wherever it is desirable to coalesce the build material composition 10. As such, the fusing agent 25 will be applied to form patterned portions 16A, 16B, the latter of which also receives the hydrophobic agent 23 to render it hydrophobic. The patterned portion 16A represents those portion(s) of the 3D object that are not to be imparted with additional hydrophobicity, and thus are not patterned with the hydrophobic agent 23. Similarly, to impart hydrophobicity to at least a portion of the 3D object layer 19, at least a portion 16B of the patterned portion 16A (which receives the fusing agent 25) is also patterned with the hydrophobic agent 23. As such, the patterned portion 16B has both the hydrophobic agent 23 and the fusing agent 25 applied thereto.

In a specific example, the fusing agent 25 and the hydrophobic agent 23 are selectively applied; and the hydrophobic agent 23 is selectively applied to an edge or a perimeter of the patterned portion 16A. Applying the hydrophobic agent 23 to an edge or perimeter of the patterned portion 16A generates an edge or perimeter of the 3D object layer that exhibits hydrophobicity. The hydrophobic agent 23 applied to the edge or perimeter can also lead to more accurate 3D object shapes and reduced rough edges, due to an evaporative cooling effect that prevents heat from dissipating into the non-patterned build material.

The amount of the fusing agent 25 that is applied per unit of the build material composition 10 in the patterned portions 16A, 16B may be sufficient to absorb and convert enough electromagnetic radiation so that the build material composition 10 in the patterned portions 16A, 16B will coalesce/fuse. The amount of the fusing agent 25 that is applied per unit of the build material composition 10 may depend, at least in part, on the energy absorber used in the fusing agent 25, the energy absorber loading in the fusing agent 25, and the polymeric material in the build material composition 10. In an example, the fusing agent 25 and the build material composition 10 are applied in a ratio ranging from 1:99 to 1:2 by mass. In another example, the fusing agent 25 and the build material composition 10 are applied in a ratio ranging from 1:20 to 1:4 by mass.

The amount of the hydrophobic agent 23 that is applied per unit of the build material composition 10 in the patterned portion 16B is sufficient to impart the desired hydrophobicity to the build material composition 10 in the patterned portion 16B. The amount of the hydrophobic agent 23 that is applied per unit of the build material composition 10 may depend, at least in part, on the paraffin wax used, the paraffin wax loading in the hydrophobic agent 23, and the polymeric material in the build material composition 10. In an example, the hydrophobic agent 23 and the build material composition 10 are applied in a ratio of 1:5 to 1:2 by mass. It is to be understood that this ratio accounts for the water (and any other component(s)) present in the hydrophobic agent 23.

The fusing agent 25 and/or the hydrophobic agent 23 may be dispensed from an applicator 32, 32″. The applicator 32, 32″ may include a thermal inkjet printhead, a piezoelectric printhead, a continuous inkjet printhead, etc., and the selective application of the fusing agent 25 and/or the hydrophobic agent 23 may be accomplished by thermal inkjet printing, piezo electric inkjet printing, continuous inkjet printing, etc. The controller may process data, and in response, control the applicator 32, 32″ to deposit the fusing agent 25 and/or the hydrophobic agent 23 onto pre-determined portion(s) of the build material composition 10 to generate the patterned portions 16A, 16B.

In some examples, the method 200 further comprises selectively applying, based on the 3D object model, a detailing agent 34 onto another portion 36 of the build material layer 14 outside of the patterned portions 16A, 16B. Similar to the example method 100, the portion(s) 36 is/are not patterned with the fusing agent 25, and thus is/are not to become part of the layer 19 of the 3D object (having a hydrophobic region 19B). The detailing agent 34 may be dispensed from an applicator 32′, in a manner similar to that described in reference to FIG. 1. In one example, the hydrophobic agent 23 may be used in place of the detailing agent 34 on portion(s) 36 as this agent does not include an energy absorber and thus may function similarly to the detailing agent 34.

It is to be understood that the selective application of any of the fusing agent 25, the hydrophobic agent 23, and/or the detailing agent 34 from the applicators 32, 32′, 32″ may be accomplished in a single printing pass or in multiple printing passes. In some examples, the agent(s) 23, 25, 34 is/are selectively applied in a single printing pass. In some other examples, the agent(s) 23, 25, 34 is/are selectively applied in multiple printing passes. In one of these examples, the number of printing passes ranges from 2 to 4. It may be desirable to apply the fusing agent 25, the hydrophobic agent 23, and/or the detailing agent 34 in multiple printing passes to increase the amount, e.g., of the energy absorber, the paraffin wax, etc. that is applied to the build material composition 10, to avoid liquid splashing, to avoid displacement of the build material composition 10, etc.

After the fusing agent 25, the hydrophobic agent 23, and/or detailing agent 34 are selectively applied in the specific portion(s) 16A, 16B, or 36 of the layer 14, the entire layer 14 of the build material composition 10 is exposed to electromagnetic radiation (shown as EMR in FIG. 3).

The electromagnetic radiation is emitted from the radiation source 30. The length of time the electromagnetic radiation is applied for, or energy exposure time, may be dependent, for example, on one or more of: characteristics of the radiation source 30; characteristics of the build material composition 10; and/or characteristics of the fusing agent 25 and the hydrophobic agent 23. The energy exposure time(s) described in regard to methods utilizing the multi-functional agent is/are also suitable for use in methods utilizing the hydrophobic agent 23 and the fusing agent 25.

It is to be understood that the electromagnetic radiation exposure may be accomplished in a single radiation event or in multiple radiation events. In an example, the exposing of the build material composition 10 is accomplished in multiple radiation events. In a specific example, the number of radiation events ranges from 3 to 8. In still another specific example, the exposure of the build material composition 10 to electromagnetic radiation may be accomplished in 3 radiation events. It may be desirable to expose the build material composition 10 to electromagnetic radiation in multiple radiation events to counteract a cooling effect that may be brought on by the amount of the fusing agent 25, the hydrophobic agent 23, and/or detailing agent 34 that is applied to the build material layer 14. Additionally, it may be desirable to expose the build material composition 10 to electromagnetic radiation in multiple radiation events to sufficiently elevate the temperature of the build material composition 10 in the portion(s) 16A, 16B without over heating the build material composition 10 in the non-patterned portion(s) 36.

The fusing agent 25 enhances the absorption of the radiation, converts the absorbed radiation to thermal energy, and promotes the transfer of the thermal heat to the build material composition 10 in contact therewith. In an example, fusing agent 25 sufficiently elevates the temperature of the build material composition 10 in the portions 16A, 16B to a temperature above the melting point or within the melting range of the polymeric material, allowing coalescing/fusing (e.g., thermal merging, melting, binding, etc.) of the build material composition 10 to take place. The application of the electromagnetic radiation forms the layer 19 of a 3D object having coalesced region 19A (without added hydrophobicity from the hydrophobic agent 23) and a hydrophobic, coalesced region 19B (with added hydrophobicity from the hydrophobic agent 23). As shown in FIG. 3, the hydrophobic region 19B is formed where the build material composition 10 has been patterned with both the fusing agent 25 and the hydrophobic agent 23 (e.g., at patterned portion 16B).

In some examples, the electromagnetic radiation has a wavelength that corresponds with the energy absorber in the fusing agent 25. Any of the examples set forth herein for the method 100 may be used in the method 200.

After the 3D object layer 19 having a hydrophobic region 19B is formed, additional layer(s) may be formed thereon to create an example of the 3D object. To form the next layer, additional build material composition 10 may be applied on the layer 19. The fusing agent 25, alone or in combination with the hydrophobic agent 23 depending on the desired hydrophobicity of the resulting additional layer, is/are then selectively applied on at least a portion of the additional build material composition 10, according to the 3D object model. The detailing agent 34 may be applied in any area of the additional build material composition 10 where coalescence is not desirable. After the fusing agent 25, the hydrophobic agent 23, and/or the detailing agent 34 is/are applied, the entire additional layer of the additional build material composition 10 is exposed to electromagnetic radiation in the manner described herein.

The application of additional build material composition 10, the selective application of the fusing agent 25, the hydrophobic agent 23, and/or the detailing agent 34, and the electromagnetic radiation exposure may be repeated a predetermined number of cycles to form the final 3D object in accordance with the 3D object model. As such, some examples of the method 200 include repeating (i) the applying of the build material composition 10, (ii) the selectively applying of the fusing agent 25, the hydrophobic agent 23, and/or the detailing agent 34, and (iii) the exposing to form a predetermined number of 3D object layers and a 3D printed object.

Color may be added during 3D printing or after the 3D object is generated by using the coloring agent described herein in reference to the multi-functional agent 12 (not shown in FIG. 3). Any example of the coloring agent (described herein in reference to printing methods which utilize the multi-functional agent 12) may be used in examples of the method 200.

In one example, the method 200 further comprises selectively applying, based on the 3D object model, a coloring agent to the patterned portions 16A, 16B. In this example, the coloring agent is applied to the build material composition 10 along with the fusing agent 25 and the hydrophobic agent 23. In this example, the colorant of the coloring agent becomes embedded throughout the coalesced/fused build material composition 10 of the 3D object layers.

In another example, the method 200 further comprises selectively applying, based on the 3D object model, a coloring agent to at least a portion of the layer 19. In this example, the coloring agent is applied to at least some of the exterior surface of the layer 19 wherever it is desirable to impart color.

In the examples disclosed herein, a 3D object may be printed in any orientation. For example, the 3D object can be printed from bottom to top, top to bottom, on its side, at an angle, or any other orientation. The orientation of the 3D object can also be formed in any orientation relative to the layering of the build material composition 10. For example, the 3D object can be formed in an inverted orientation or on its side relative to the layering of the build material composition 10. The orientation of the build within each layer 14 can be selected in advance or even by the user at the time of printing, for example.

To further illustrate the present disclosure, examples are given herein. It is to be understood that these examples are provided for illustrative purposes and are not to be construed as limiting the scope of the present disclosure.

### EXAMPLES

### Example 1

A comparative example of a printing fluid (comparative fluid 1) and an example of the multi-functional agent disclosed herein (example fluid 2) were each prepared. Example fluid 2 included a paraffin wax as the hydrophobic component, a humectant/co-solvent, a radiation-absorbing dye, a surfactant, and a balance of water. In this example, comparative fluid 1 included the same components as Example fluid 2 without any hydrophobic component(s). The formulation of each respective fluid is shown in Table 1:

TABLE 1

| | | Comparative Fluid 1 | Example Fluid 2 |
|---|---|---|---|
| Component | Function | (wt % active) | |
| Propylene glycol | Humectant | 15.00 | 15.0 |
| Cyan-854 | Radiation | 2.5 | 2.5 |
| | absorber | | |
| AQUACER ™ 497 | Paraffin | 0 | 15.0 |
| | dispersion | | |
| TERGITOL | Surfactant | 0.75 | 0.75 |
| 15-S-9 | | | |
| Deionized Water | Carrier | Balance | Balance |

After each fluid was prepared, comparative fluid 1 and example fluid 2 were each respectively used to generate a comparative 3D part and an example 3D part. The parts were printed on a 365 nm-fusing lamp equipped multi jet fusion printer. The build material used to generate the parts was polyamide-12. The polyamide-12 build material was spread out into thin layers. Comparative fluid 1 and example fluid 2 were inkjet printed on each build material layer in a respective pattern for that portion. The loading of each composition was about 1.5 drops per pixel. Each patterned layer was exposed to visible radiation to fuse the layer. These processes were repeated for 50 individual layers, each having a height of about 80 μm, to ultimately form the printed part(s).

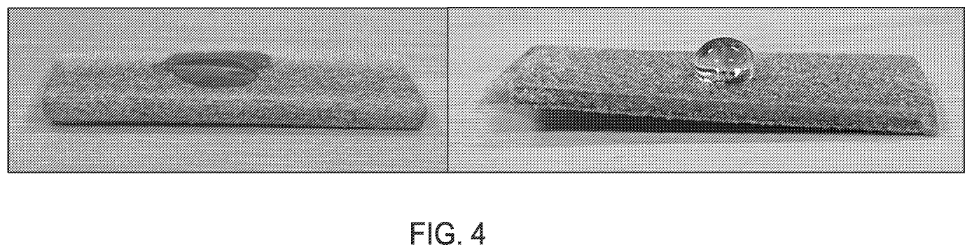

After each part was formed, a 100 μL drop of deionized water was placed on a surface of each printed part so the resultant contact angle could be observed. The results are shown in the black-and-white photograph depicted in FIG. 4. As can be seen, the example 3D part, which was prepared using an example of the multi-functional agent, (shown in the picture on the right in FIG. 4) displayed a much larger contact angle (and thus better hydrophobic properties) relative to the comparative 3D (shown in the picture on the left in FIG. 4). The contact angle was increased for the example 3D part by at least 27 degrees, relative to the comparative 3D part.

### Prophetic Example 2

A comparative printing fluid (comparative fluid 3) and an example of the multi-functional 3D printing fluid disclosed herein (example fluid 4) are prepared. In this example, comparative fluid 3 includes a radiation-absorbing dye, a co-solvent, a surfactant, antimicrobial agents, a chelating agent, an anti-kogation agent, and a balance of water (without a perfluorinated polymer). Example fluid 4 includes a perfluorinated polymer as the hydrophobic component, a humectant, a radiation-absorbing dye, a surfactant, an anti-kogation agent, and a balance of water. The formulation of each respective fluid is shown in Table 2:

TABLE 2

| | | Wt % active | |
|---|---|---|---|
| | | Comparative | Example |
| Component | Function | Fluid 3 | Fluid 4 |
| DOWANOL ™ TPM | Humectant | 0 | 15.0 |
| Carbon black | Radiation | 10 | 0 |
| dispersion | absorber | | |
| Acid yellow 23 | Radiation | 0 | 0.1-5 |
| | absorber | | |
| 3M DYNEON ™ | Fluoropolymer | 0 | 10.0 |
| PFA 6910 GZ | dispersion | | |
| TERGITOL ™ | Surfactant | 0 | 0.75 |
| 15-S-9 | | | |
| TEGO ® Wet 510 | Surfactant | 0.75 | 0 |
| 2-pyrrolidone | Co-solvent | 25 | 0.11 |
| ACTICIDE ® B20 | Antimicrobial | 0.04 | 0 |
| | agent | | |
| ACTICIDE ® M20 | Antimicrobial | 0.015 | 0 |
| | agent | | |
| CRODAFOS ™ | Anti-kogation | 0.45 | 0 |
| O3A | agent | | |
| CRODAFOS ™ N3 | Anti-kogation | 0 | 0.5 |
| | agent | | |
| TRILON ® M | Chelating agent | 0.08 | 0 |
| Deionized Water | Carrier | Balance | Balance |

It is believed that example fluid 4 is suitable for printing onto a build material composition to form a patterned layer. The patterned layer would then be exposed to visible light to form a printed part having hydrophobic properties. It is further believed that if water were applied to 3D printed parts generated using example fluid 4, these parts would display a higher contact angle (e.g., at least 20 degrees higher), relative to a part generated using comparative fluid 3.

It is to be understood that the ranges provided herein include the stated range and any value or sub-range within the stated range. For example, from about 5 wt % active to about 20 wt % active should be interpreted to include not only the explicitly recited limits of from about 5 wt % active to about 20 wt % active, but also to include individual values, such as about 7 wt % active, about 12.5 wt % active, about 15 wt % active, about 18 wt % active, etc., and sub-ranges, such as from about 5 wt % active to about 10 wt % active, from about 8.5 wt % active to about 12.5 wt % active, from about 13 wt % to about 18 wt %, etc. Furthermore, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. A multi-functional agent for three-dimensional printing, comprising:
an aqueous vehicle;
a hydrophobic component dispersed in the aqueous vehicle, the hydrophobic component being selected from the group consisting of a perfluorinated polymer and a paraffin wax; and
an energy absorber dispersed in the aqueous vehicle.

2. The multi-functional agent as defined in claim 1, wherein:
the hydrophobic component is the perfluorinated polymer; and
the perfluorinated polymer is selected from the group consisting of a perfluoroalkoxy alkane, poly(tetrafluoroethylene), a perfluorinated polyether, fluorinated ethylene propylene, and combinations thereof.

3. The multi-functional agent as defined in claim 1, wherein:
the hydrophobic component is the perfluorinated polymer; and
the perfluorinated polymer is present in a total amount ranging from about 5 wt % active to about 20 wt % active, based on a total weight of the multi-functional agent.

4. The multi-functional agent as defined in claim 1, wherein:
the hydrophobic component is the perfluorinated polymer; and
the energy absorber is selected from the group consisting of an infrared radiation absorbing non-self-dispersed pigment, an infrared radiation absorbing dye, a visible radiation absorbing pigment, a visible radiation absorbing dye, and an ultraviolet radiation absorber.

5. The multi-functional agent as defined in claim 1, wherein:
the hydrophobic component is the paraffin wax; and
the paraffin wax has from 15 carbon atoms to 200 carbon atoms.

6. The multi-functional agent as defined in claim 1, wherein:
the hydrophobic component is the paraffin wax; and
the paraffin wax is present in a total amount ranging from about 5 wt % active to about 20 wt % active, based on a total weight of the multi-functional agent.

7. The multi-functional agent as defined in claim 1, wherein:
the hydrophobic component is the paraffin wax; and
the energy absorber is selected from the group consisting of an infrared radiation absorbing self-dispersed pigment, an infrared radiation absorbing dye, a visible radiation absorbing pigment, a visible radiation absorbing dye, and an ultraviolet radiation absorber.

8. The multi-functional agent as defined in claim 1, further comprising an additive selected from the group consisting of a humectant, an anti-kogation agent, a surfactant, and combinations thereof.

9. The multi-functional agent as defined in claim 1, wherein the aqueous vehicle is selected from the group consisting of water, a water-soluble or water-miscible organic solvent, and combinations thereof.

10. The multi-functional agent as defined in claim 1 wherein:
the hydrophobic component is the perfluorinated polymer, and the perfluorinated polymer has a mean particle size ranging from about 50 nm to about 195 nm; or
the hydrophobic component is the paraffin wax, and the paraffin wax has a mean particle size ranging from about 100 nm to 400 nm.

11. A fluid set for three-dimensional printing, comprising:
a hydrophobic agent including:
a paraffin wax having a mean particle size ranging from about 100 nm to 400 nm; and
an aqueous vehicle; and
a fusing agent including an energy absorber having absorption at visible light wavelengths, infrared radiation wavelengths, ultraviolet radiation wavelengths, or combinations thereof.

12. The fluid set as defined in claim 11 wherein the paraffin wax is present in a total amount ranging from about 5 wt % active to about 20 wt % active, based on a total weight of the hydrophobic agent.

13. The fluid set as defined in claim 11 wherein the aqueous vehicle further comprises an additive selected from the group consisting of a humectant, an anti-kogation agent, a surfactant, and combinations thereof.

14. A method for printing a hydrophobic three-dimensional object, comprising:
applying a polymeric build material to form a build material layer;
based on a 3D object model, selectively applying either:
i) a multi-functional agent onto at least a portion of the build material layer, the multi-functional agent including:
an aqueous vehicle;
a hydrophobic component dispersed in the aqueous vehicle, the hydrophobic component being selected from the group consisting of a perfluorinated polymer and a paraffin wax; and
an energy absorber dispersed in the aqueous vehicle; or
ii) a fusing agent onto the build material layer, thereby forming a patterned portion; and
a hydrophobic agent onto at least a portion of the patterned portion, wherein the hydrophobic agent includes a paraffin wax having a mean particle size ranging from about 50 nm to about 195 nm; and
exposing the build material layer to energy to selectively coalesce i) the at least the portion or ii) the patterned portion.

15. The method as defined in claim 14, wherein;
the fusing agent and the hydrophobic agent are selectively applied; and
the hydrophobic agent is selectively applied to an edge or a perimeter of the patterned portion.
